(19) United States
(12) Patent Application Publication
(10) Pub. No.: US 2013/0275024 A1
(43) Pub. Date: Oct. 17, 2013

(54) ENGINE CONTROL DEVICE

(71) Applicants: Shinji Nakagawa, Mito (JP); Akihito Numata, Hitachiomiya (JP); Eisaku Fukuchi, Mito (JP)

(72) Inventors: Shinji Nakagawa, Mito (JP); Akihito Numata, Hitachiomiya (JP); Eisaku Fukuchi, Mito (JP)

(73) Assignee: Hitachi Automotive Systems, Ltd.

(21) Appl. No.: 13/700,277

(22) PCT Filed: Jun. 3, 2011
(86) PCT No.: PCT/JP11/62752

§ 371 Date: Jun. 25, 2013

(30) Foreign Application Priority Data
Jun. 4, 2010 (JP) 2010-128408

(51) Int. Cl. F02D 41/00

(52) U.S. Cl. CPC F02D 41/00
USPC 701/102

(57) ABSTRACT

Variations in the air-fuel ratio among cylinders are specified as one cause of deterioration in exhaust emissions however the size of the variations in the air-fuel ratio among cylinders detected by the catalyst upstream sensor does not always match the margin of deterioration in exhaust emissions. The objective of the present invention is to detect the deterioration in the exhaust emissions caused due to variations in the air-fuel ratio among cylinders. Deterioration in exhaust emissions due to variations in the air-fuel ratio among engine cylinders is detected based on a means to calculate a specified frequency component A of the catalyst upstream sensor signal; a means to calculate a specified frequency component B of the catalyst downstream sensor signal; and the frequency component A and the frequency component B.

### TECHNICAL FIELD

The present invention relates to an engine exhaust performance diagnosis and engine control device, and relates in particular to a device for diagnosing deterioration in exhaust emissions caused by variations in the air-fuel ratio among cylinders or regulating the correction of exhaust emission deterioration.

### BACKGROUND ART

Global environmental problems have led to a demand for lower exhaust emissions in automobiles. There have been a variety of technical developments up until now relating to diagnostic functions that notify the driver when exhaust performance has deteriorated beyond a specified level by monitoring exhaust performance in real-time in the actual driving environment. Automobile engines generally utilized multiple cylinders. Variations in the air-fuel ratio among cylinders have been specified as causing deterioration in exhaust emissions.

Patent document 1 discloses an invention to detect the air-fuel ratio in each cylinder from the specified frequency components in the catalyst upstream air-fuel ratio sensor signal. Patent document 2 discloses an invention for determining variations in the air-fuel ratio in each cylinder when the catalyst downstream air-fuel ratio sensor signal is on the lean side for a specified period or longer.

### CITATION LIST

### Patent Literature

Patent document 1: Japanese Unexamined Patent Application Publication No. 2000-220489
Patent document 2: Japanese Unexamined Patent Application Publication No. 2009-30455

### SUMMARY OF INVENTION

### Technical Problem

Variations occurring in the air-fuel ratio among cylinders have been specified as causing deterioration in exhaust emissions. However, the inventors found through experimentation that the size of the variation in the air-fuel ratio among cylinders in the catalyst upstream sensor does not always match the margin of exhaust emission deterioration. This mismatch is thought to occur due to a difference in sensor sensitivity per the exhaust from each cylinder; and due to a change in balance of the reducing agent quantity and oxygen quantity within the exhaust caused by the variation pattern. Moreover, the catalyst downstream sensor essentially detects the air-fuel ratio within the catalyst and so is capable of detecting the exhaust emission (HC, CO, NOx) cleansing performance of the exhaust emission. However pinpointing the elements causing variations in air-fuel ratio among cylinders leading to exhaust emission deterioration is difficult, and continuous transient operation under actual environmental conditions leads to moment-by-moment changes in the catalyst downstream sensor signals so that constantly detecting the deterioration in exhaust emission deterioration is also difficult.

### Solution to Problem

In view of the aforementioned circumstances, the present invention has the object of detecting with fine accuracy the deterioration in exhaust emissions caused by variations in the air-fuel ratio among cylinders.

Namely, an engine control device as shown in FIG. 1 includes a means to calculate a specified frequency component A of the catalyst upstream sensor signal, a means to calculate a specified frequency component B of the catalyst downstream sensor signal, and a means to detect the deterioration in exhaust emissions from the variation in the air-fuel ratio among the engine cylinders based on the specified frequency component A and the specified frequency component B. The detecting means detects the occurrence of variations in the air-fuel ratio among cylinders from the specified frequency component A of the catalyst upstream sensor signal, or detects in what range the state represented by the component ratio of the exhaust emission such as for the catalyst upstream air-fuel ratio is being controlled. Moreover, the means detects the state represented by the component ratio of the exhaust such as for the air-fuel ratio of the downstream of the catalyst or within the catalyst, from the specified frequency component B of the catalyst downstream sensor signal. The means detects the deterioration in exhaust emissions from the variation in the air-fuel ratio among cylinders by utilizing both the specified frequency component A and the specified frequency component B.

FIG. 2 shows an engine control device utilizing the structure in FIG. 1 as a precondition, and in which the catalyst upstream sensor is an air-fuel ratio sensor or an oxygen sensor; and the catalyst downstream sensor is an air-fuel ratio sensor or an oxygen sensor. The catalyst upstream sensor is an air-fuel ratio sensor or an oxygen sensor as already described. The catalyst downstream sensor is also an air-fuel ratio sensor or an oxygen sensor.

An engine control device as shown in FIG. 3 also utilizing the structure in FIG. 1 as a precondition, in which a means to calculate a specified frequency component A is a means to calculate the frequency component equivalent to the period that the engine makes two revolutions (hereafter, two revolution component). As can be seen in FIG. 25 and FIG. 26, when a variation occurs in the air-fuel ratio among cylinders, an oscillation occurs in the period (720 deg CA period) that the engine makes two revolutions appears in the catalyst upstream sensor (air-fuel sensor, oxygen sensor) signal.

An engine control device also utilizing the structure shown in FIG. 3 as a precondition, in which the means to calculate the two revolution component A as shown in FIG. 4, is a band-pass filter or is Fourier conversion (transform). As previously described, a band-pass filter or Fourier conversion is utilized as the means for calculating the two revolution component shown in claim 3.

An engine control device utilizing the structure shown in FIG. 1 as a precondition, and in which the means to calculate the specified frequency component B, as shown in FIG. 5, is at least a means for calculating a frequency component B lower than a frequency equivalent to the period that the engine makes two revolutions. As previously described, the catalyst downstream air-fuel ratio sensor or catalyst downstream oxygen sensor detects most of the air-fuel ratio within the catalyst so that the cleansing performance of the exhaust emissions (HC, CO, NOx) by the catalyst can be detected from the catalyst downstream sensor signal.

However, continuous transient operation under actual environmental conditions leads to moment-by-moment changes in the catalyst downstream sensor signals so that constant detection of exhaust emission deterioration is also difficult. Whereupon, calculating the low frequency component of the catalyst downstream sensor signal to remove the moment-by-moment fluctuating components, allows detecting just the direct current component (average value) and so detects the constant cleansing performance (exhaust emission deterioration). The low frequency component may be set as a frequency component lower than a frequency equivalent to the period that the engine makes two revolutions but as already described the goal is to detect a direct current component so that utilizing an even lower component is allowable.

Also engine control device utilizing the structure shown in FIG. 5 as a precondition, and in which the means to calculate the specified frequency component B as shown in FIG. 6, is a low pass filter. As already described, a low pass filter is utilized as the means to calculate the low frequency component B as shown in claim 5.

An engine control device utilizing the structure shown in FIG. 3 as a precondition includes a means to decide that a variation has occurred in the air-fuel ratio when the two revolution component A exceeds a specified value as shown in FIG. 7.

The two revolution component of the catalyst upstream sensor (air-fuel ratio sensor or oxygen sensor) signal becomes larger when a variation in air-fuel ratio among cylinders is detected as shown in claim 3. Even during normal operation the variation in air-fuel ratio among cylinders has a specified variation from characteristic variations in the fuel injection valve and intake air variations among cylinders. Therefore, only the variation in the exhaust emission bad enough to cause deterioration need to be detected and a decision is made that a variation in the air-fuel ratio among cylinders has occurred when the two revolution component A has exceeded a specified value (usually, enough to cause deterioration in exhaust emissions) as described in claim 7.

An engine control device utilizing the structure shown in FIG. 3 as a precondition includes a means for calculating the frequency of occurrence Ra at which the two revolution component exceeds a specified value as shown in FIG. 8. Statistical (quantitative) processing is utilized in order to more accurately detect the size of the two revolution component of the catalyst upstream sensor signal. The means calculates the frequency of occurrence Ra at which the two revolution component A is exceeded as described in claim 8. When recalculating the two revolution component for each combustion for example, then the frequency of occurrence Ra is utilized and is a value at which the number of combustions is set as the denominator, and the number of the two revolution components exceeding a specified value is set as the numerator.

An engine control device utilizing the structure shown in FIG. 5 as a precondition includes a means for calculating the frequency of occurrence Rb at which the low frequency component B deviates from a specified range as shown in FIG. 9. Statistical processing is utilized to detect the distribution of the low frequency component of the catalyst downstream sensor signal more accurately. As described in claim 9, this means calculates the frequency of occurrence Rb at which the low frequency component B deviates from a specified range. When for example recalculating the two revolution component per individual combustions, the frequency of occurrence Rb is utilized and is the value of the number of combustions set as the denominator, and the number of times the low frequency components deviated from the specified range set as the numerator. Here, the specified range may be set as the value at which the catalyst cleansing efficiency exceeds a specified range. When the catalyst downstream sensor is an oxygen sensor for example, then a low frequency component that is lower than a specified range signifies that the air-fuel ratio within the catalyst or catalyst downstream flow is lean so that the NOx value has deteriorated. A low frequency component that is larger than a specified range signifies that the air-fuel ratio within the catalyst or catalyst downstream flow is rich so that mainly the CO value has deteriorated.

An engine control device utilizing the structure shown in FIG. 8 or FIG. 9 as a precondition includes a means to judge that the exhaust emissions downstream of the catalyst have worsened due to variations in the air-fuel ratio among cylinders “when the frequency of occurrence Ra exceeded a specified value for the two revolution component A that exceeded a specified value, and moreover the frequency of occurrence Rb exceeded a specified value for the low frequency component B that deviated from the specified range” as shown in FIG. 10. Then, as related in the description for claim 8 and claim 9, a variation in the air-fuel ratio among cylinders large enough to cause deterioration in exhaust emissions is judged to have occurred when the frequency of occurrence Ra exceeded a specified value for the two revolution component A of the catalyst upstream sensor signal that exceeded the specified value, and moreover an actual deterioration in the exhaust emissions is judged to have occurred when the frequency of occurrence Rb at which the low frequency component (B) of the catalyst downstream sensor signal deviated from the specified range, has exceeded a specified value.

Also, an engine control device utilizing the structure shown in FIG. 8 or FIG. 9 as a precondition, and in which the means for calculating the specified frequency component A is a means for calculating a frequency component A lower than a frequency equivalent to the period that the engine makes two revolutions. When variations in the air-fuel ratio among cylinders occur, the size of the two revolution component detected by the catalyst upstream sensor signal fluctuates due to the installation position of the catalyst upstream sensor. When unable to sufficiently detect the two revolution component, the deterioration in exhaust emissions can be detected from the low frequency component of the catalyst downstream sensor, and the accuracy for judging the low frequency component of the catalyst downstream sensor can be increased by detecting in what range the low frequency component of the catalyst upstream sensor signal is located.

An engine control device utilizing the structure shown in FIG. 11 as a precondition, and in which the means for calculating the specified frequency component A is a low pass filter as shown in FIG. 12. As already described, a low pass filter is utilized as the means for calculating the low frequency component A shown in claim 11.

An engine control device utilizing the structure shown in FIG. 5 or FIG. 11 as a precondition includes a means for calculating a frequency of occurrence Rc in which “the low frequency component A is within the specified range, and the low frequency component B is deviating from the specified range.” For example, when the low frequency component A of the catalyst upstream sensor signal is within a specified range equivalent to the high efficiency cleansing range of the catalyst, and the low frequency component B of the catalyst downstream sensor (signal) is deviating from a specified range equivalent to the high efficiency cleansing range of the catalyst, then a faulty detection has probably occurred in the catalyst upstream sensor due to the variation in the fuel-ratio among cylinders and a judgment is made that exhaust emission deterioration has occurred. That frequency of occurrence is then found in order to raise the judgment accuracy. When for example recalculating the low frequency component A and the low frequency component B at each combustion, the frequency of occurrence Rc is the value at which the number of combustions is set as the denominator and the number of times that the low frequency component deviated from the specified range is set as the numerator.

An engine control device utilizing the structure shown in FIG. 13 as a precondition includes a means to judge there is deterioration in catalyst downstream exhaust emissions due to variations in the air-fuel ratio among cylinders when the frequency of occurrence Rc has exceeded a specified value. As already described, deterioration in the catalyst downstream exhaust emissions due to variations in the air-fuel ratio among cylinders is judged to have occurred when the frequency of occurrence Rc exceeded a specified value.

An engine control device utilizing the structure shown in any of FIG. 1 through FIG. 14 as a precondition includes at least a means to calculate a specified frequency component A, a means to calculate a specified frequency component B, and a means to detect deterioration in the exhaust emissions in order to control the catalyst upstream sensor output within a specified range when implementing feedback control to regulate the engine operating state as shown in FIG. 15. The engine control device implements the meanss for one or any one of the claim 1 through 14 items with the precondition that the catalyst upstream sensor output is a value equivalent to the high efficiency range of the catalyst. If the catalyst upstream sensor output is not within the high efficiency cleansing range of the catalyst then the catalyst downstream sensor output has deviated from the specified range (high efficiency cleansing range of the catalyst) due to a cause other than variations in the air-fuel ratio among cylinders. The object of feedback control by the catalyst upstream sensor is to provide control within the high efficiency cleansing range of the catalyst so the control is applied during feedback. Even if the catalyst upstream sensor output is within a range equivalent to the high efficiency range of the catalyst, this state does not signify that the actual state of exhaust components such as the actual air-fuel ratio is in the high efficiency cleansing range of the catalyst. The reason is that the exhaust emission deterioration is due to faulty detection error by the catalyst upstream sensor caused by variations in the air-fuel ratio among cylinders.

An engine control device utilizing the structure shown in any of FIG. 1 through FIG. 14 as a precondition executes at least a means to calculate a specified frequency component A, a means to calculate a specified frequency component B, and a means to detect that the exhaust emissions have deteriorated when the “catalyst upstream exhaust sensor output” or the “average value in a specified period of the catalyst upstream exhaust sensor output” is in a specified range, as shown in FIG. 16. The objective here is the same as the contents already described in claim 15. The engine control device executes the means of any or any one of the claim 1 through claim 14 along with the precondition that at least the catalyst upstream sensor output is a value equivalent to the high efficiency range of the catalyst.

An engine control device utilizing the structure shown in FIG. 8 as a precondition includes a means for correcting the fuel injection quantity or the intake air quantity based on the size of the two revolution component A as shown in FIG. 17. The size of the two revolution component in the catalyst upstream sensor output correlates to the extent of variations in the air-fuel ratio among cylinders as already described and so the device can correct the fuel injection quantity or the intake air quantity based on the size of the two revolution component. When a faulty detection occurs in the catalyst upstream exhaust sensor due to the variation in air-fuel ratio among cylinders, then the deviation from the catalyst high efficiency cleansing range is the cause of the exhaust emission deterioration. Therefore if the fuel quantity or the air quantity for all cylinders is corrected according the size of the two revolution component then the state of the catalyst upstream exhaust can return to the catalyst high efficiency cleansing range, and exhaust emission deterioration can be prevented.

An engine control device utilizing the structure shown in FIG. 3 as a precondition includes a means for correcting the feedback control correction value based on the catalyst upstream sensor signal and/or correcting the feedback correction value based on the catalyst downstream sensor signal, based on the size of the two revolution component, as shown in FIG. 18.

The present invention corrects the feedback control correction value based on the catalyst upstream sensor signal and/or corrects the feedback correction value based on the catalyst downstream sensor signal.

An engine control device utilizing the structure shown in FIG. 8 as a precondition includes a means for correcting the fuel injection quantity or the intake air quantity based on the frequency of occurrence Ra as shown in FIG. 19. The present invention corrects the fuel injection quantity or the intake air quantity based on the frequency of occurrence Ra that the two revolution component exceeds the specified value.

An engine control device utilizing the structure shown in FIG. 8 as a precondition includes a means for correcting the feedback control correction value based on the catalyst upstream sensor signal and/or correcting the feedback correction value based on the catalyst downstream sensor signal, based on the frequency of occurrence Ra, as shown in FIG. 20. The present invention corrects the feedback control correction value based on the catalyst upstream sensor signal and/or corrects the feedback correction value based on the catalyst downstream sensor signal.

An engine control device utilizing the structure shown in FIG. 3 or FIG. 5 as a precondition includes a means for correcting the fuel injection quantity or the intake air quantity so that the low frequency component B enters within the specified range, when the two revolution component A exceeded the specified value as shown in FIG. 21. In addition to the previous structure, by correcting the fuel injection quantity or the intake air quantity so that the low frequency component of the catalyst downstream sensor output enters within the specified range (the catalyst high efficiency cleansing range), the present invention can suppress exhaust emission deterioration with greater accuracy.

An engine control device utilizing the structure shown in FIG. 3 or FIG. 5 as a precondition includes a means for correcting the feedback control correction value based on the catalyst upstream sensor signal and/or correcting the feedback correction value based on the catalyst downstream sensor signal so that the low frequency component B enters within the specified range, when the two revolution component A exceeded the specified value as shown in FIG. 22. The present invention corrects the feedback control correction value based on the catalyst upstream sensor signal and/or corrects the feedback correction value based on the catalyst downstream sensor signal.

An engine control device utilizing the structure shown in FIG. 8 or FIG. 9 as a precondition includes a means for correcting the fuel injection quantity or the intake air quantity based on the frequency of occurrence Rb “when the frequency of occurrence Ra exceeded a specified value, and moreover the frequency of occurrence Rb exceeded a specified value” as shown in FIG. 23. In addition to the previous structure, by correcting the fuel injection quantity or the intake air quantity based on the frequency of occurrence Rb at which the low frequency component of the catalyst downstream sensor output deviates from a specified range (the catalyst high efficiency cleansing range) the present invention can suppress exhaust emission deterioration with greater accuracy.

An engine control device utilizing the structure shown in FIG. 8 or FIG. 9 as a precondition includes a means for correcting the feedback control correction value based on the catalyst upstream sensor signal and/or correcting the feedback correction value based on the catalyst downstream sensor signal, based on the frequency of occurrence Rb, “when the frequency of occurrence Ra exceeded a specified value, and moreover the frequency of occurrence Rb exceeded a specified value” as shown in FIG. 24. The present invention corrects the feedback control correction value based on the catalyst upstream sensor signal and/or corrects the feedback correction value based on the catalyst downstream sensor signal.

An engine control device utilizing the structure shown in FIG. 8 or FIG. 11 as a precondition includes a means for correcting the fuel injection quantity or the intake air quantity so that the low frequency component B enters the specified range when the low frequency component A is within the specified range as shown in FIG. 25. When unable to sufficiently detect the two revolution component in the catalyst upstream sensor signal, the exhaust emission deterioration can be detected from the low frequency component of the catalyst downstream sensor, and the judgment accuracy by the low frequency component of the catalyst downstream sensor can be increased by detecting in what range the low frequency component of the catalyst upstream sensor signal is located. The fuel injection quantity or the intake air quantity is corrected so that the low frequency component of the catalyst downstream sensor signal enters the specified range and so the present invention can suppress exhaust emission deterioration at this time.

An engine control device utilizing the structure shown in FIG. 5 or FIG. 11 as a precondition includes a means for correcting the feedback control correction value based on the catalyst upstream sensor signal and/or correct the feedback correction value based on the catalyst downstream sensor signal so that the low frequency component B enters the specified range when the low frequency component A is within the specified range as shown in FIG. 26. The present invention corrects the feedback control correction value based on the catalyst upstream sensor signal and/or corrects the feedback correction value based on the catalyst downstream sensor signal.

### Advantageous Effects of Invention

The present invention detects variations in the air-fuel ratio among cylinders from the specified frequency component of the catalyst upstream sensor signal and moreover detects exhaust emission deterioration from the specified frequency component of the catalyst downstream sensor signal and so renders the effect of detecting with good accuracy the deterioration in the exhaust emissions caused by variations in the air-fuel ratio among cylinders by utilizing both of these information items.

### BRIEF DESCRIPTION OF DRAWINGS

FIG. 1 is a block diagram equivalent to the engine control device according to claim 1;

FIG. 2 is a block diagram equivalent to the engine control device according to claim 2;

FIG. 3 is a block diagram equivalent to the engine control device according to claim 3;

FIG. 4 is a block diagram equivalent to the engine control device according to claim 4;

FIG. 5 is a block diagram equivalent to the engine control device according to claim 5;

FIG. 6 is a block diagram equivalent to the engine control device according to claim 6;

FIG. 7 is a block diagram equivalent to the engine control device according to claim 7;

FIG. 8 is a block diagram equivalent to the engine control device according to claim 8;

FIG. 9 is a block diagram equivalent to the engine control device according to claim 9;

FIG. 10 is a block diagram equivalent to the engine control device according to claim 10;

FIG. 11 is a block diagram equivalent to the engine control device according to claim 11;

FIG. 12 is a block diagram equivalent to the engine control device according to claim 12;

FIG. 13 is a block diagram equivalent to the engine control device according to claim 13;

FIG. 14 is a block diagram equivalent to the engine control device according to claim 14;

FIG. 15 is a block diagram equivalent to the engine control device according to claim 15;

FIG. 16 is a block diagram equivalent to the engine control device according to claim 16;

FIG. 17 is a block diagram equivalent to the engine control device according to claim 17;

FIG. 18 is a block diagram equivalent to the engine control device according to claim 18;

FIG. 19 is a block diagram equivalent to the engine control device according to claim 19;

FIG. 20 is a block diagram equivalent to the engine control device according to claim 20;

FIG. 21 is a block diagram equivalent to the engine control device according to claim 3 or claim 5 of the present invention;

FIG. 22 is a block diagram equivalent to the engine control device according to claim 3 or claim 5 of the present invention;

FIG. 23 is a block diagram equivalent to the engine control device according to claim 8 or claim 9 of the present invention;

FIG. 24 is a block diagram equivalent to the engine control device according to claim 8 or claim 9 of the present invention;

FIG. 25 is a block diagram equivalent to the engine control device according to claim 5 or claim 11 of the present invention;

FIG. 26 is a block diagram equivalent to the engine control device according to claim 5 or claim 11 of the present invention;

FIG. 27 is a drawing showing the catalyst upstream air-fuel ratio sensor signal when there are air-fuel variations and when there are no air-fuel variations among the cylinders;

FIG. 28 is a drawing showing the catalyst upstream air-fuel oxygen sensor signal when there are air-fuel variations and when there are no air-fuel variations among the cylinders;

FIG. 29 is a pictorial diagram of the engine control system according to the first through the sixth embodiments;

FIG. 30 is a pictorial diagram showing the internal section of the control unit in the first through the sixth embodiments;

FIG. 31 is a block diagram showing overall control in the first embodiment;

FIG. 32 is a block diagram for the diagnostic approval unit in the first through second embodiments;

FIG. 33 is a block diagram of the two revolution component processing unit in the first and the third through the fifth embodiments;

FIG. 34 is a block diagram of the low frequency component 2 processing unit in the first and the third through the sixth embodiments;

FIG. 35 is a block diagram of the frequency of occurrence Ra processing unit in the first and the third through the fifth embodiments;

FIG. 36 is a block diagram of the frequency of occurrence Rb processing unit in the first and the third through the fifth embodiments;

FIG. 37 is a block diagram of the abnormal judgment unit in the first and the third through the fifth embodiments;

FIG. 38 is a block diagram showing the overall control in the second embodiment;

FIG. 39 is a block diagram of the low frequency component 1 processing unit in the second and sixth embodiments;

FIG. 40 is a block diagram of the frequency of occurrence Rc processing unit in the second and the sixth embodiments;

FIG. 41 is a block diagram of the abnormal judgment unit in the second and the sixth embodiments;

FIG. 42 is a block diagram showing the overall control in the third embodiment;

FIG. 43 is a block diagram of the basic fuel injection quantity processing unit in the third through the sixth embodiments;

FIG. 44 is a block diagram of the catalyst upstream air-fuel ratio feedback control unit of the third, the fifth, and the sixth embodiments;

FIG. 45 is a block diagram of the catalyst downstream air-fuel ratio feedback control unit of the third and the sixth embodiments;

FIG. 46 is a block diagram of the catalyst downstream air-fuel ratio feedback approval unit in the third embodiment;

FIG. 47 is a block diagram showing the overall control of the fourth embodiment:

FIG. 48 is a block diagram of the catalyst upstream air-fuel ratio feedback control unit of the fourth embodiment;

FIG. 49 is a block diagram of the catalyst downstream air-fuel ratio feedback control unit of the fourth embodiment;

FIG. 50 is a block diagram of the catalyst downstream air-fuel ratio feedback control approval unit of the fourth embodiment;

FIG. 51 is a block diagram showing the overall control of the fifth embodiment:

FIG. 52 is a block diagram of the catalyst downstream air-fuel ratio feedback control unit of the fifth embodiment;

FIG. 53 is a block diagram of the catalyst downstream air-fuel ratio feedback approval unit in the fifth embodiment;

FIG. 54 is a block diagram showing the overall control of the sixth embodiment:

FIG. 55 is a block diagram of the catalyst downstream air-fuel ratio feedback control approval unit of the fifth embodiment.

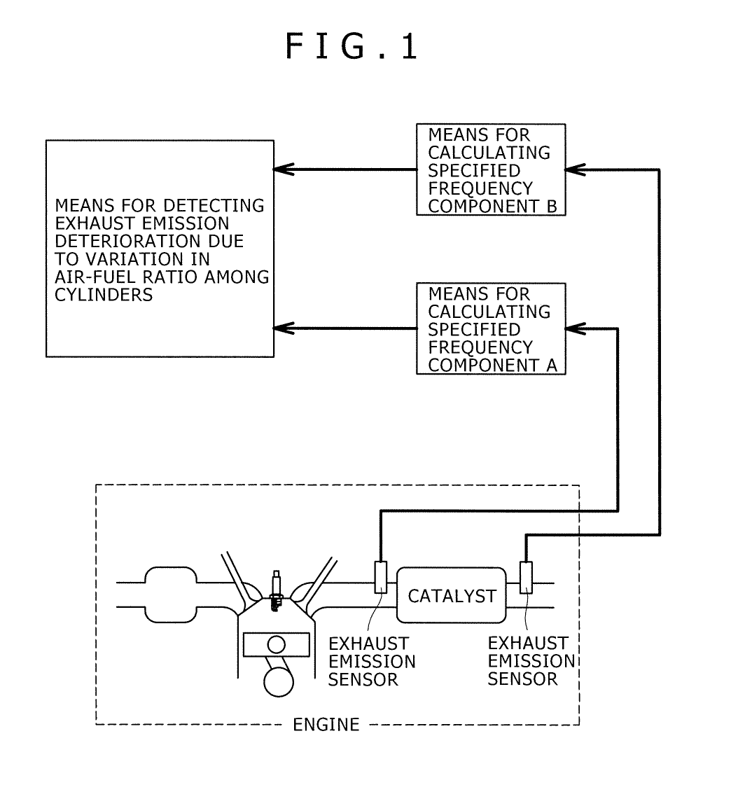

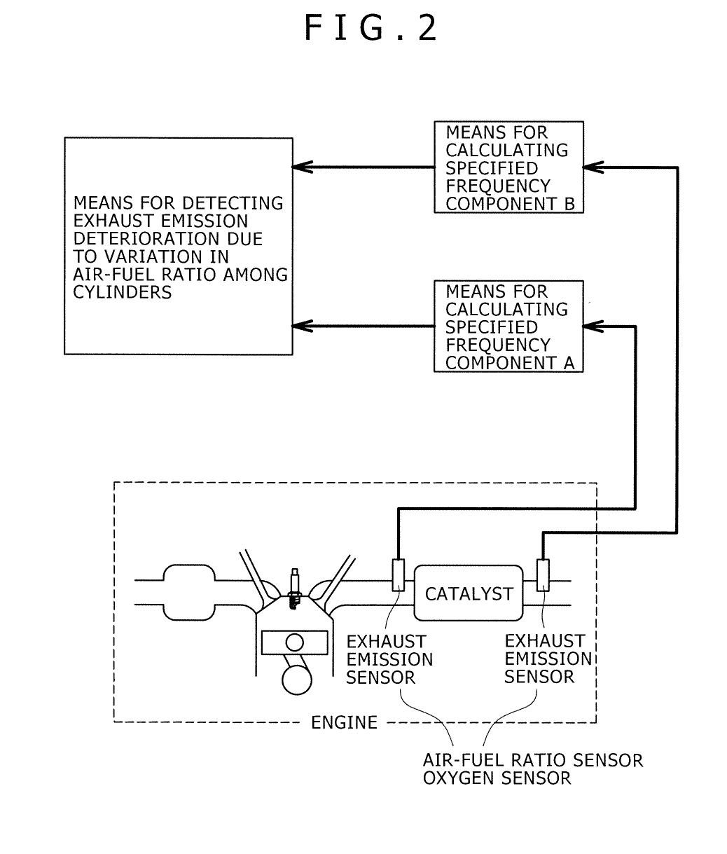

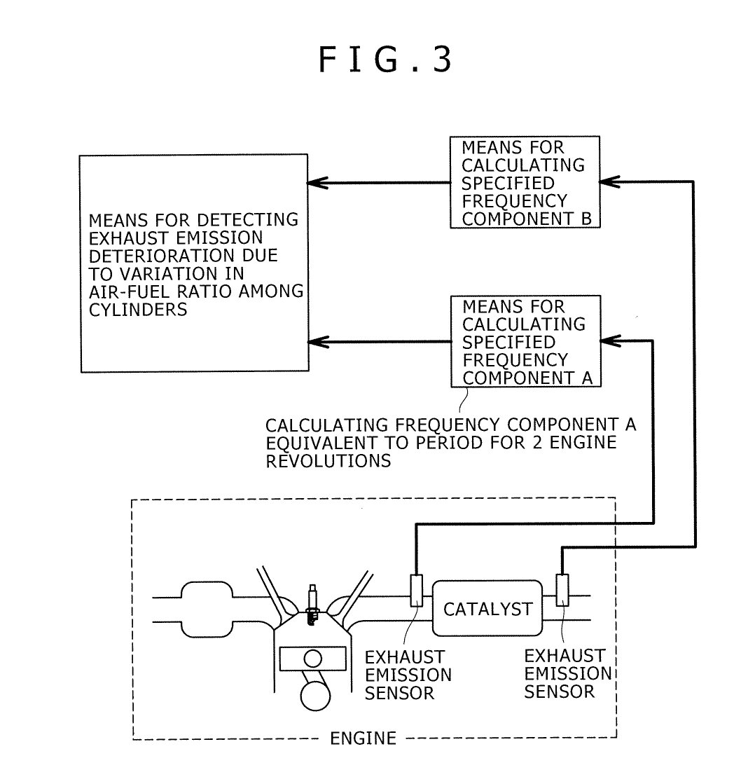

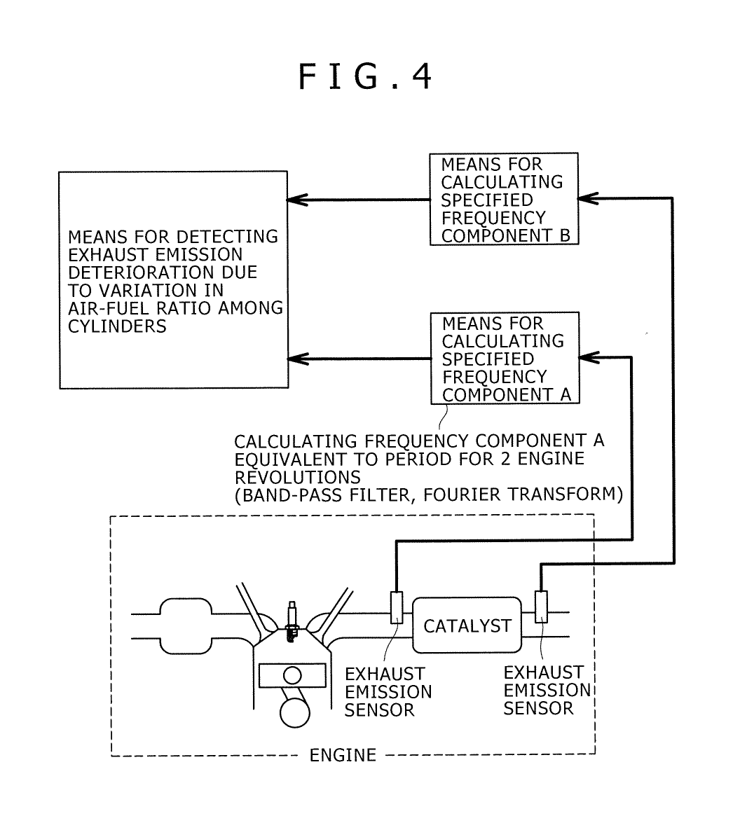

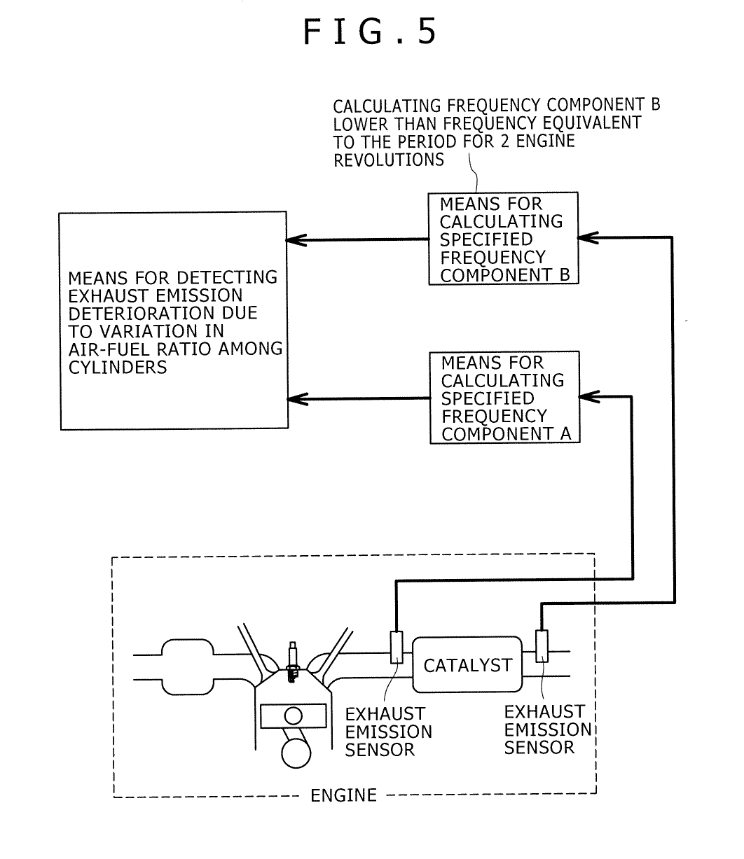

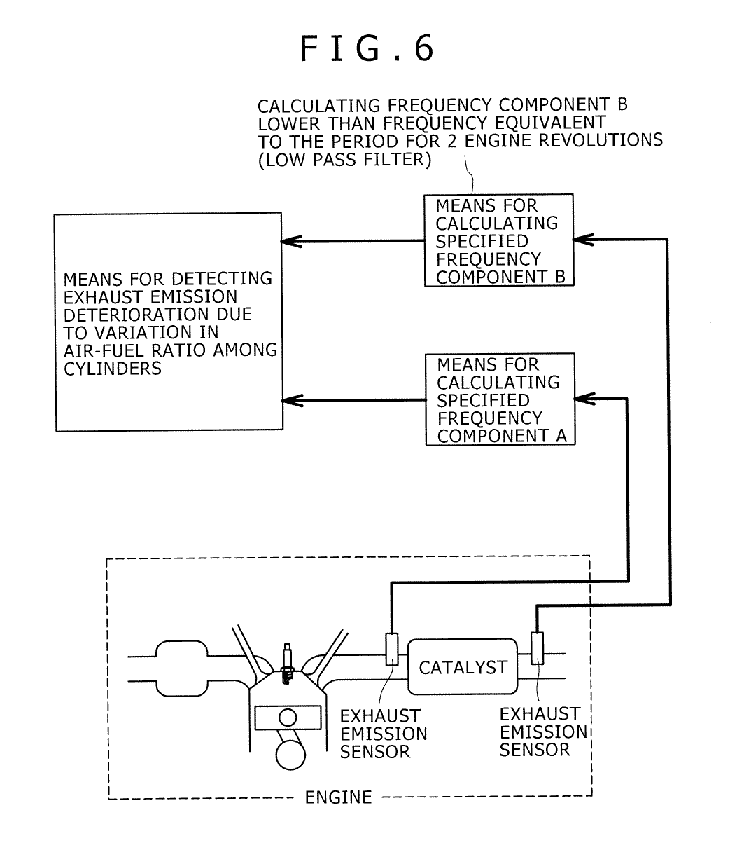

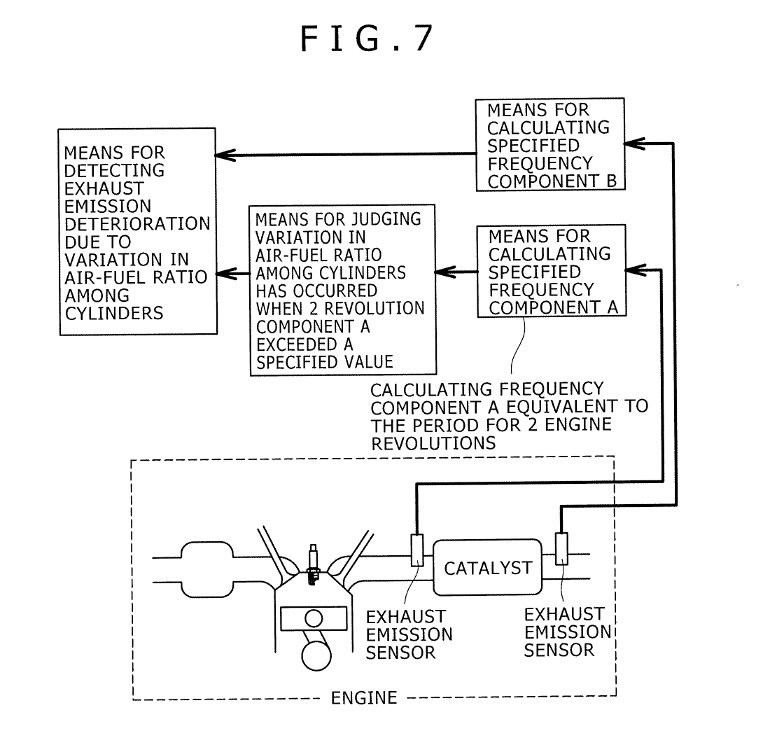

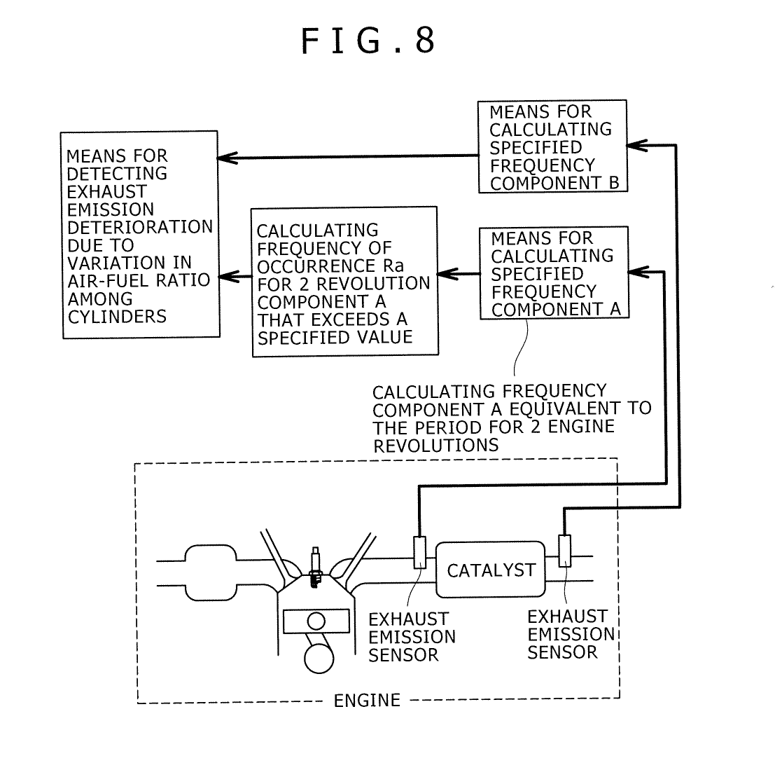

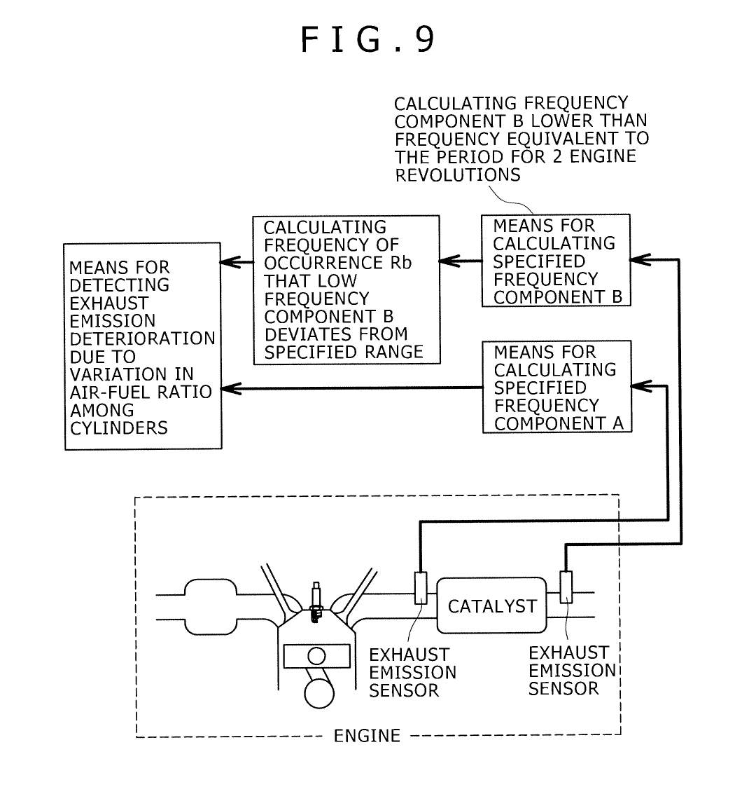

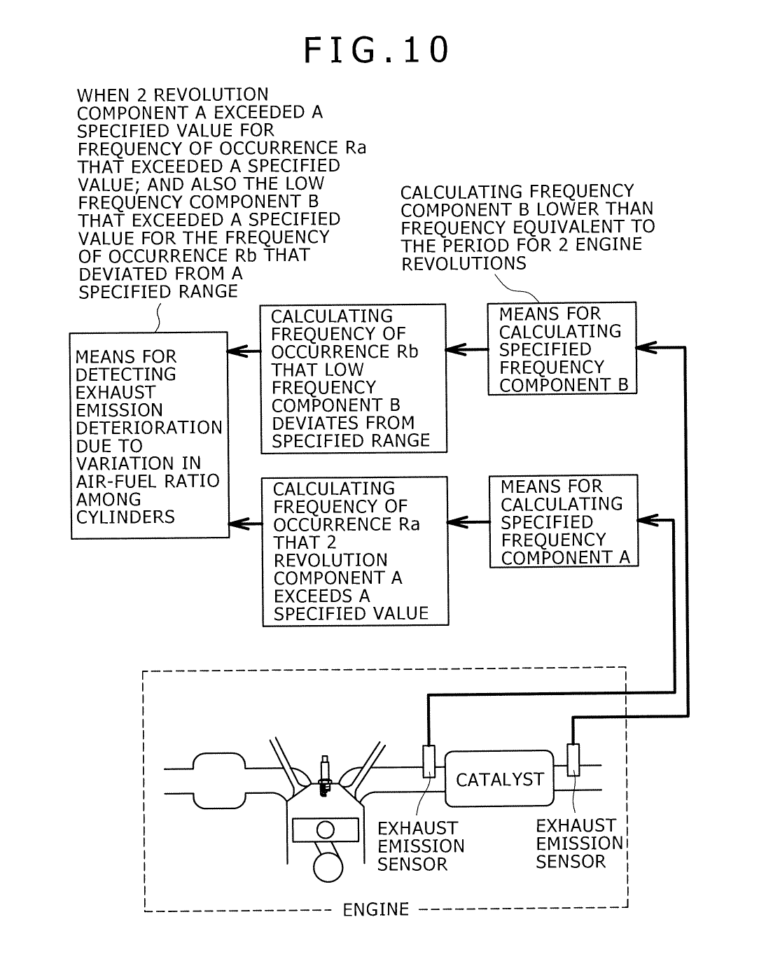

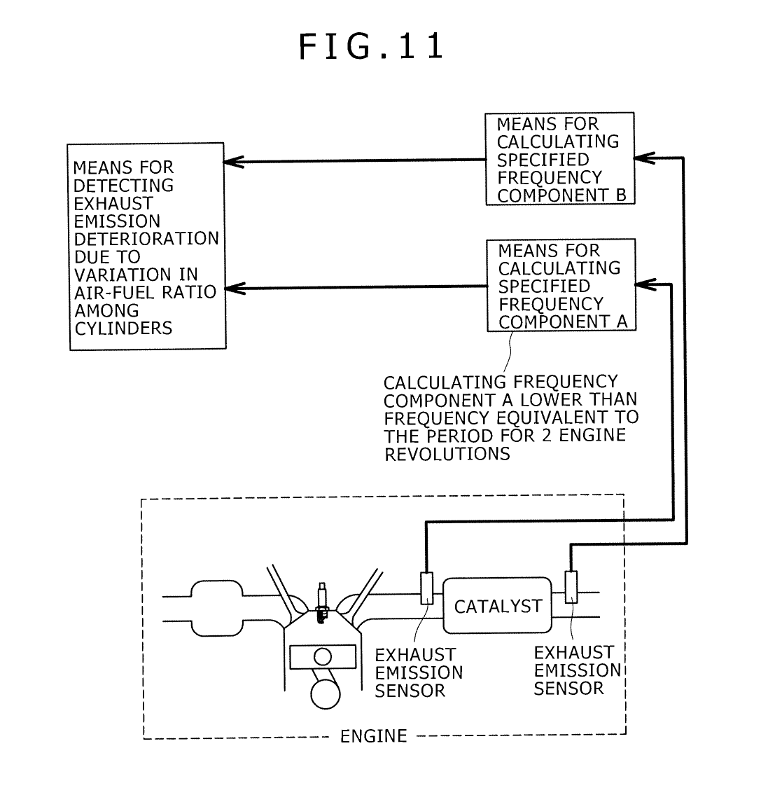

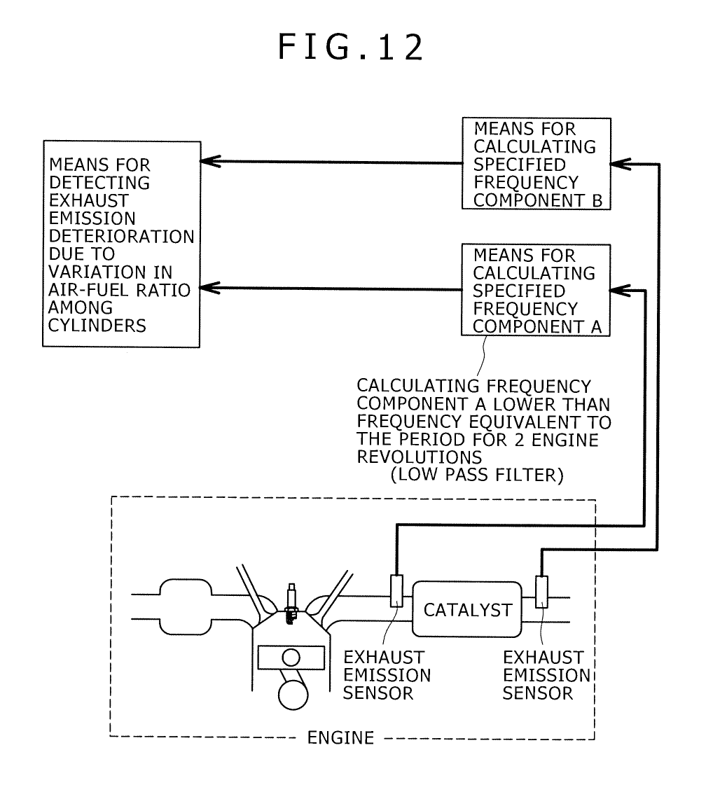

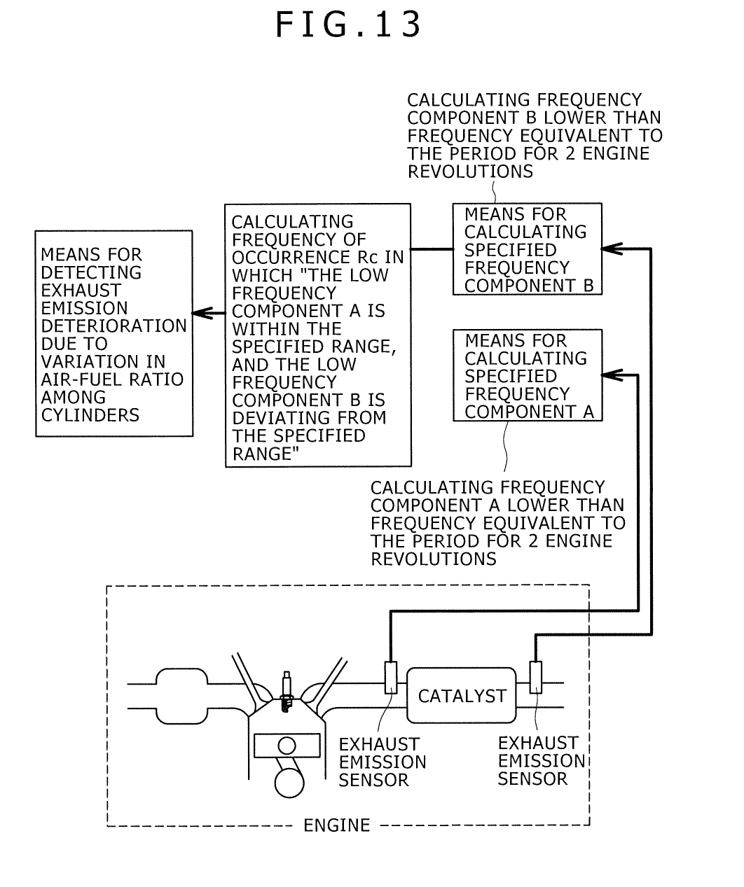

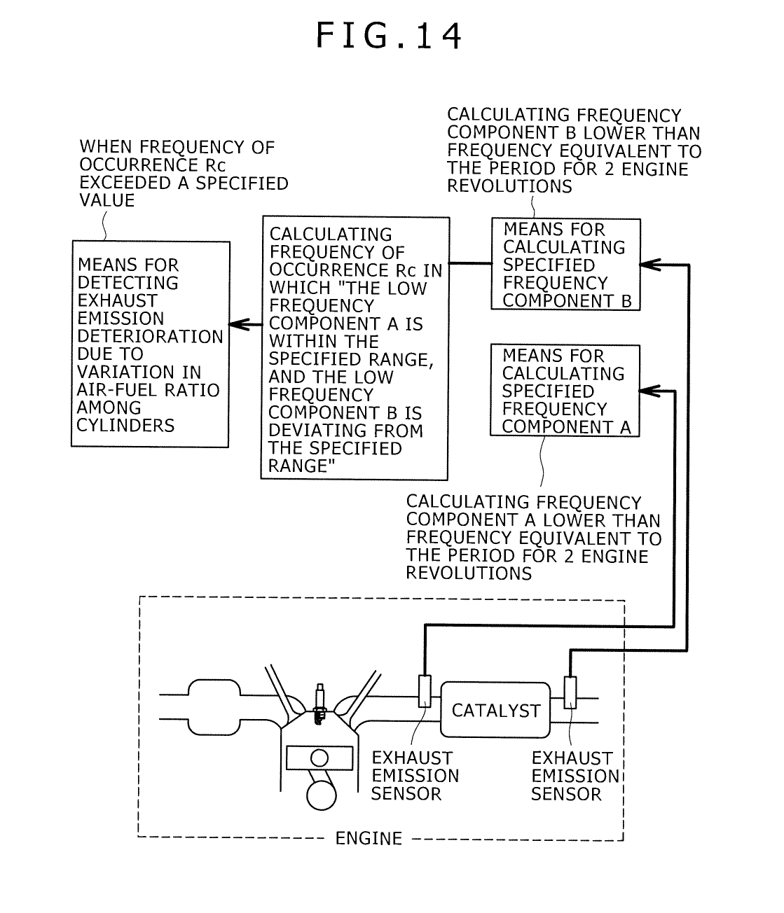

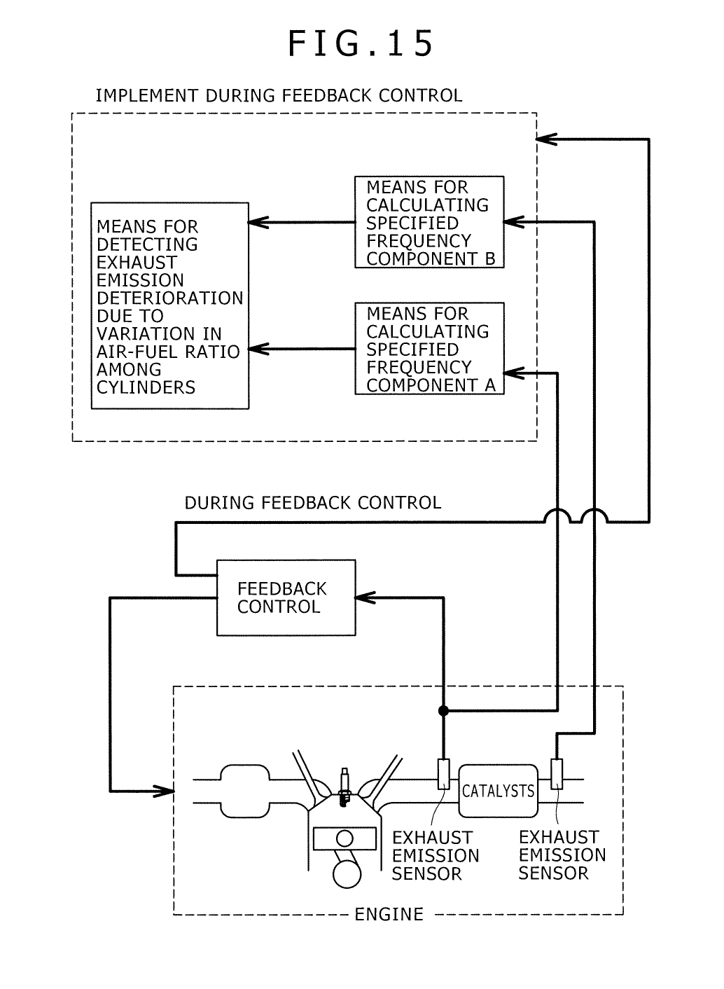

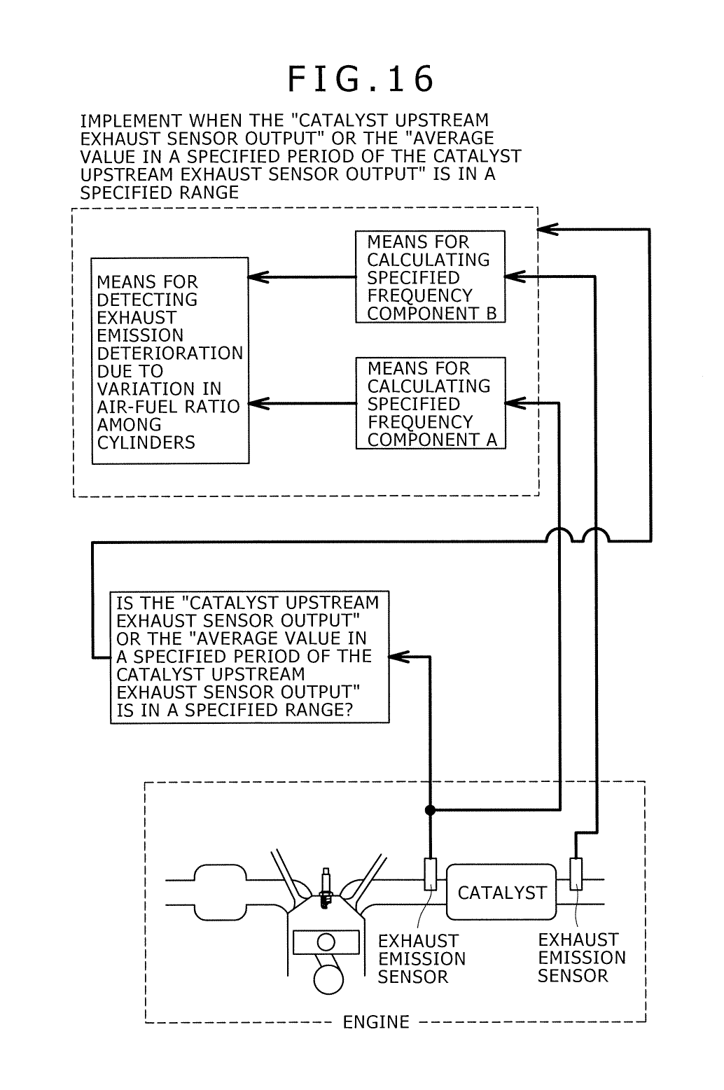

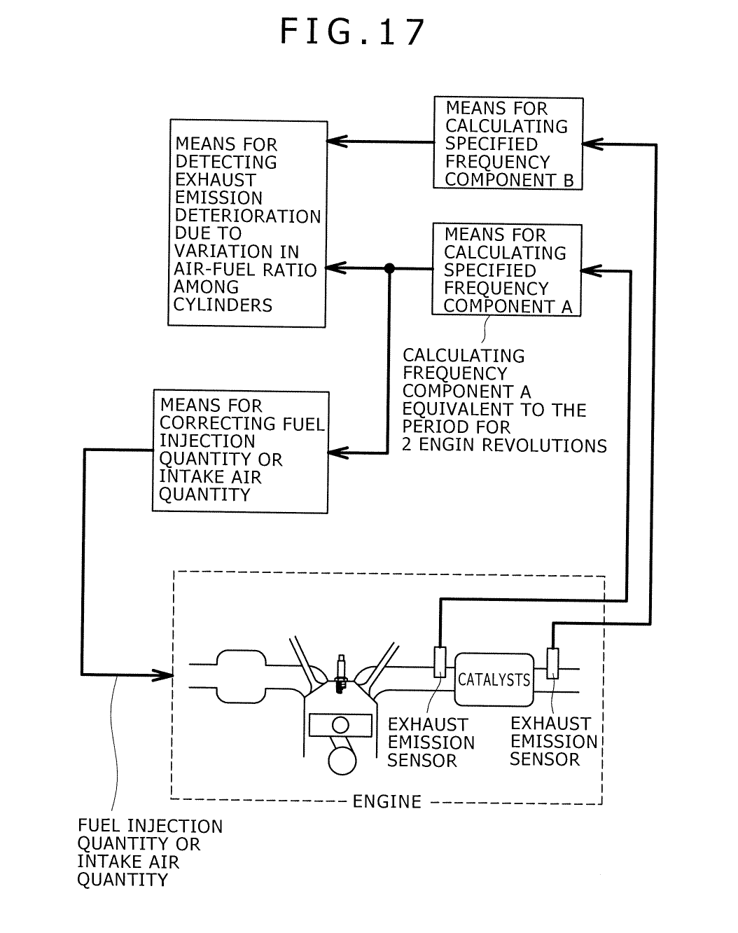

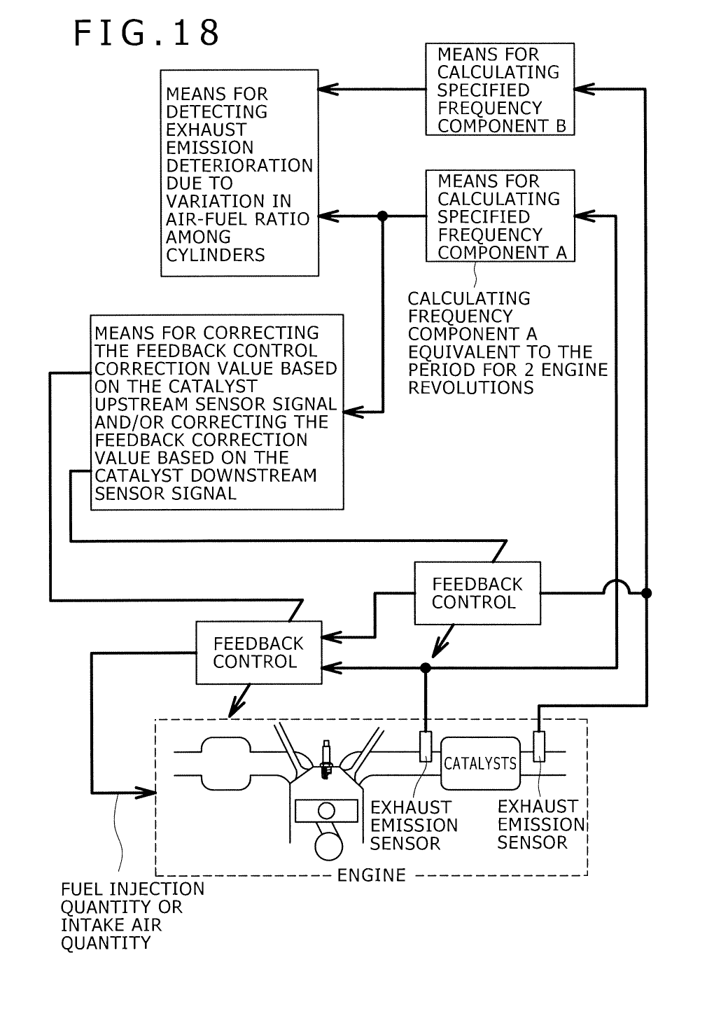

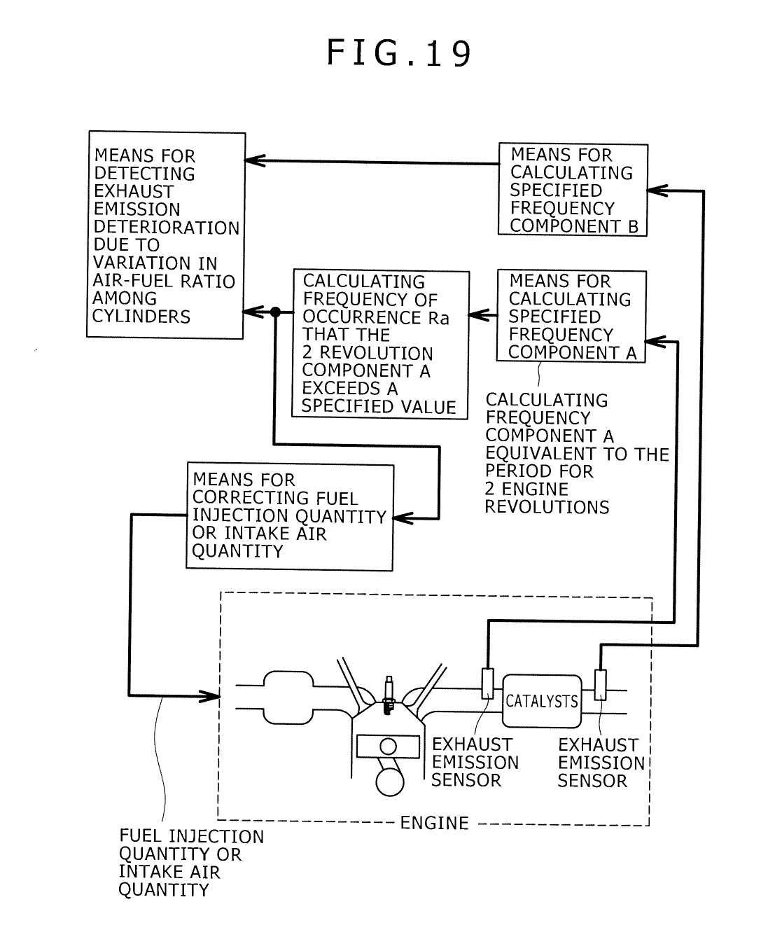

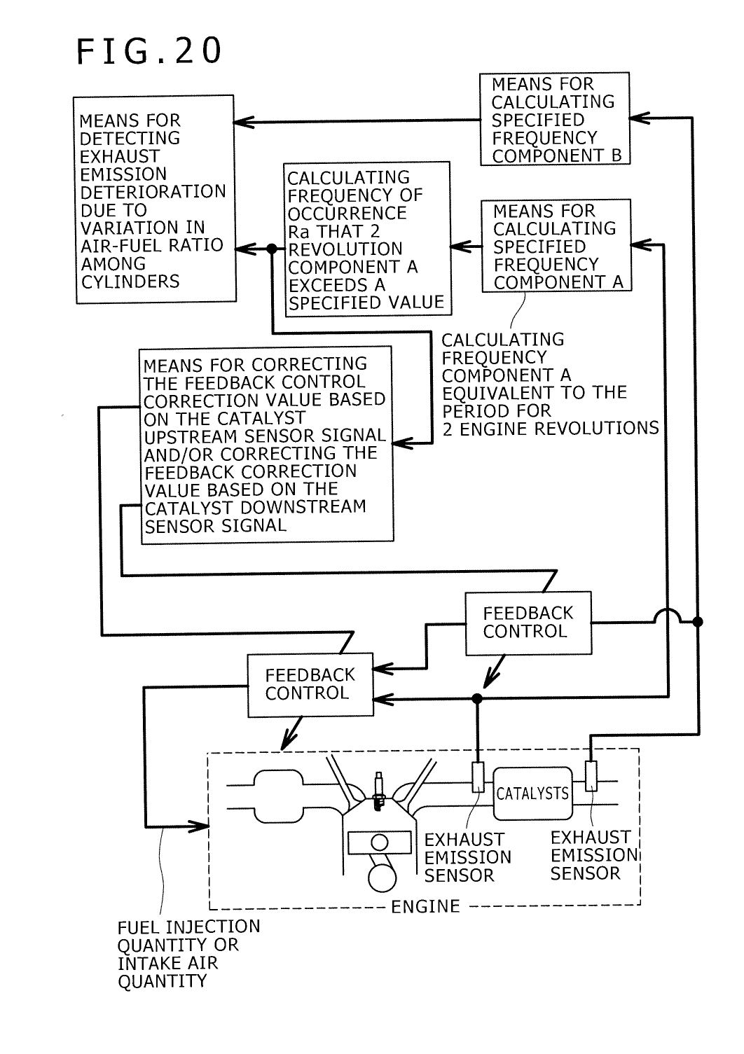

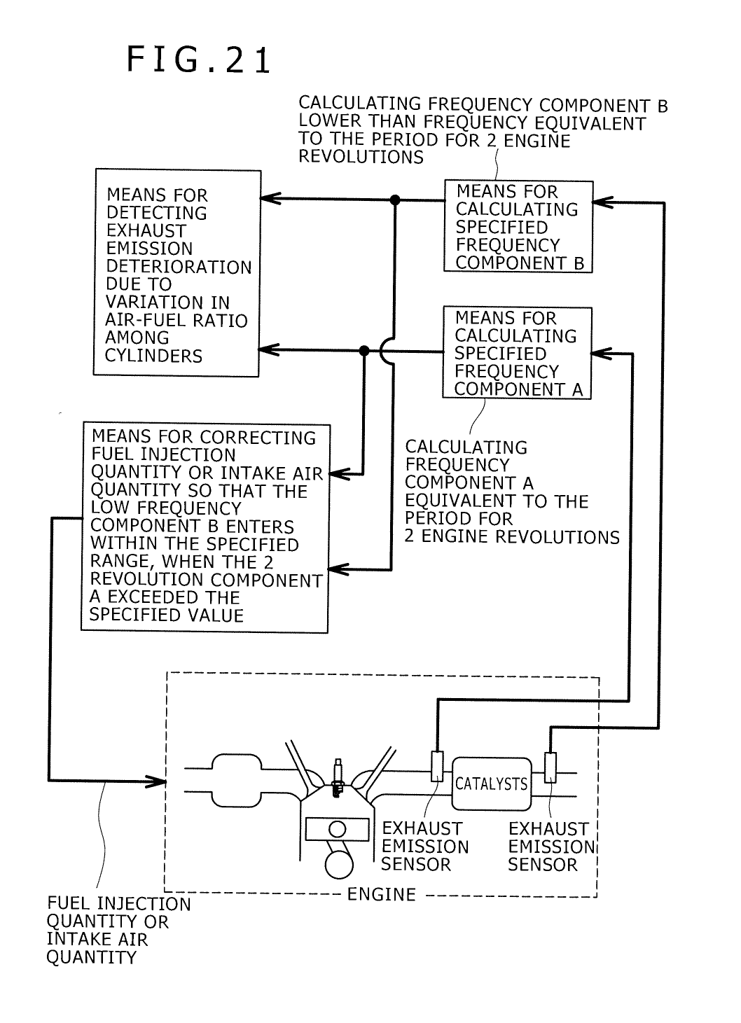

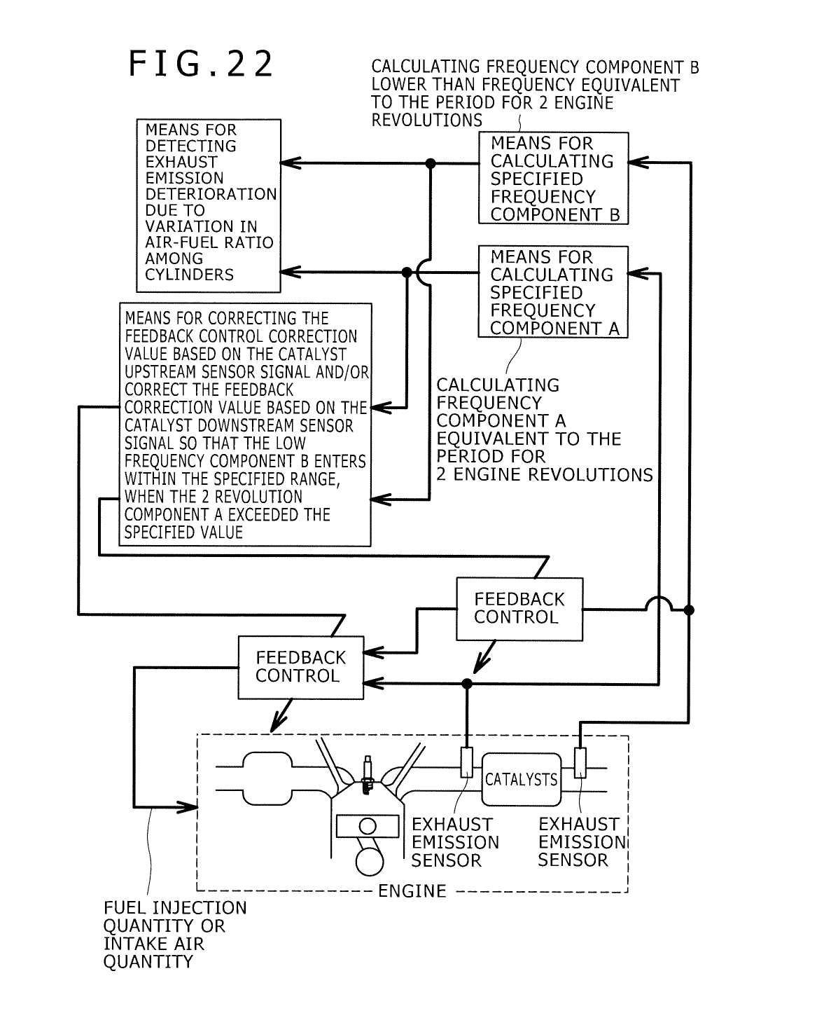

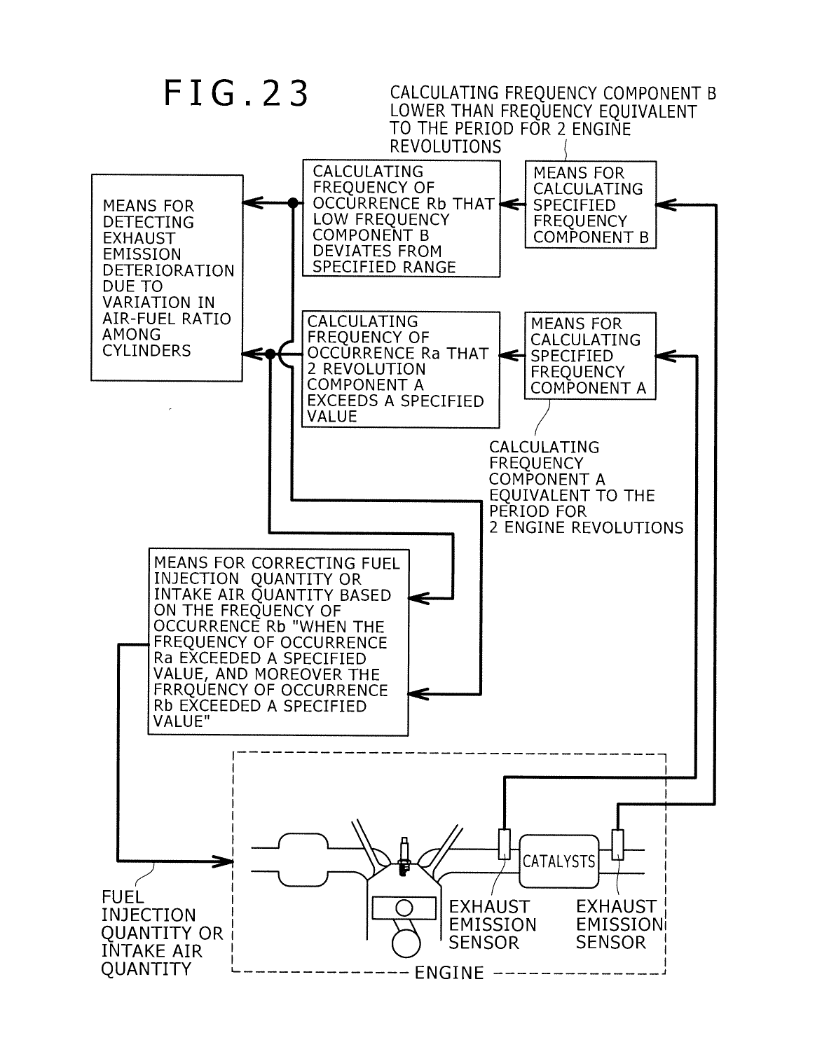

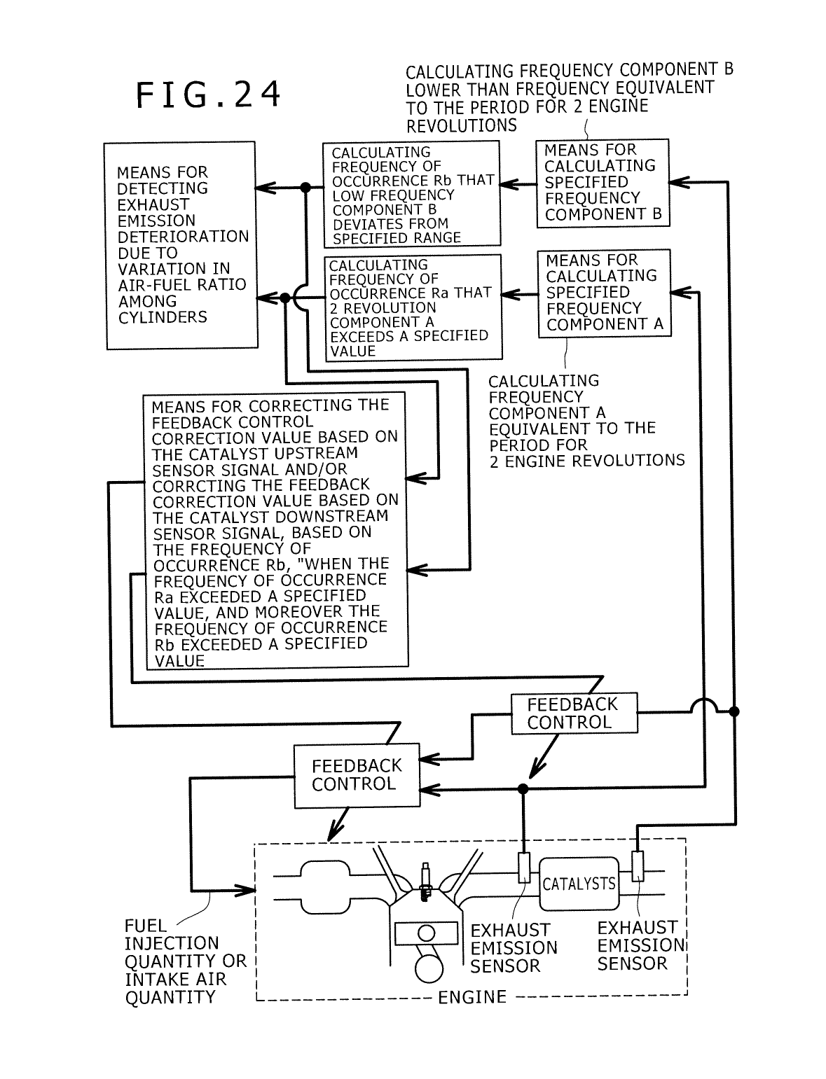

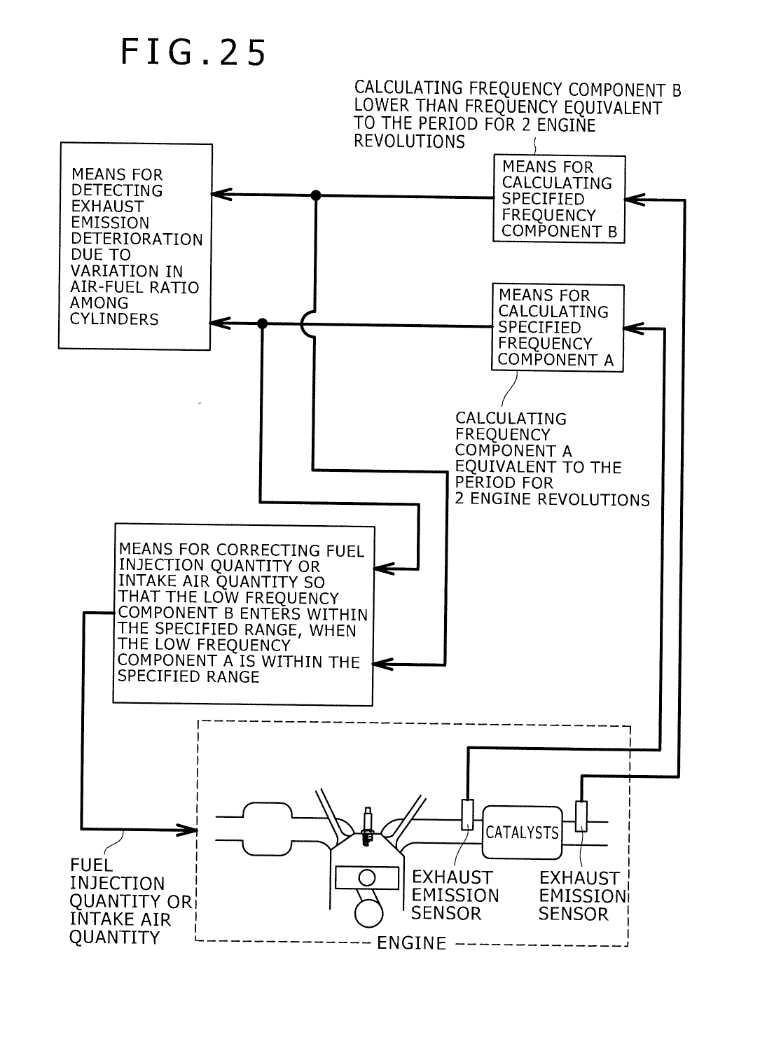

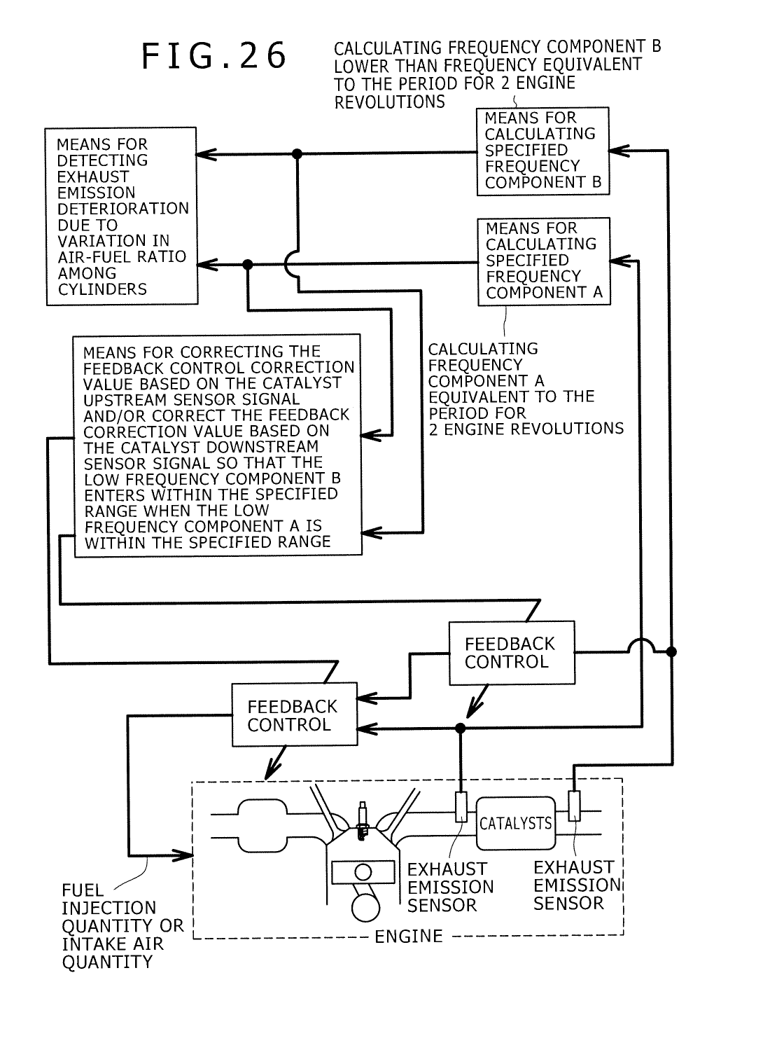

### DESCRIPTION OF EMBODIMENTS

The embodiments of the present invention are described as follows:

### First Embodiment

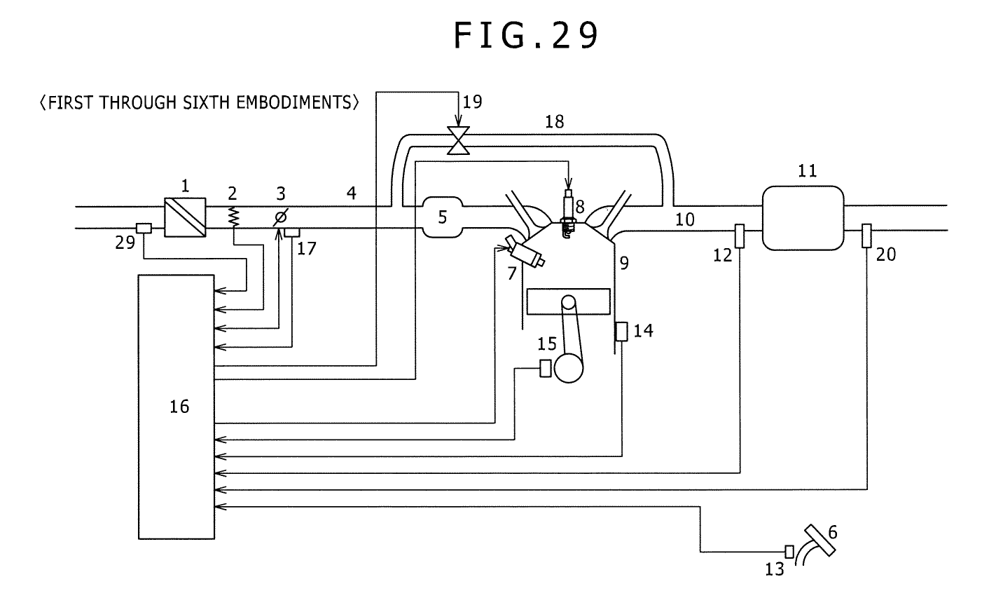

FIG. 29 is a system diagram of the present embodiment. In the engine 9 comprised of multiple cylinders (here, four cylinders), the outside air passes through an air cleaner 1 and enters into the cylinder after passing through an intake pipe 4 and a collector 5. An electronic throttle 3 adjusts air inflow quantity. An air flow sensor 2 detects the intake air flow quantity. An intake air temperature sensor 29 detects the intake air heat temperature. A crank angle sensor 15 outputs a signal for every 10 degrees of turning angle and a signal for every combustion cycle. A water temperature sensor 14 detects the coolant water temperature of the engine. An accelerator opening sensor 13 detects the amount of foot pressure on an accelerator 6, and in this way detects the torque needed by the driver.

The respective signals from the accelerator opening sensor 13, the air flow sensor 2, the intake air temperature sensor 29, a throttle angle sensor 17 installed on the electronic throttle 3, the crank angle sensor 15 and the water temperature sensor 14 are sent to a control unit 16 described later on, the engine operating state obtained from these sensor outputs, and the optimal airflow quantity, fuel injection quantity, and major operating quantities of the engine during the ignition period are calculated.

The target airflow quantity calculated in the control unit 16, is converted from a target throttle opening to an electronic throttle drive signal, and sent to the electronic throttle 3. The fuel injection quantity is converted to a valve opening pulse signal, and sent to a fuel injection valve (injector) 7. A drive signal for ignition in the ignition period calculated in the control unit 16 is sent to a spark plug 8.

The injected fuel is mixed with air from the intake manifold and flow inside the cylinder of an engine 9 to form the air-fuel mixture. The spark from the spark plug 8 cause the air-fuel mixture to explode at the specified ignition period, and that combustion pressure pushes the piston downward to serve as propulsion for the engine. The exhaust after the explosion is fed by way of the exhaust pipe 10 into the three-way catalyst 11. A portion of the exhaust passes through an exhaust return pipe 18 and is returned to the intake side. A valve 19 regulates the return quantity.

A catalyst upstream sensor 12 (in the first embodiment, an air-fuel rate sensor) is installed between the engine 9 and the three-way catalyst 11. A catalyst downstream oxygen sensor 20 is installed downstream of the three-way catalyst 11.

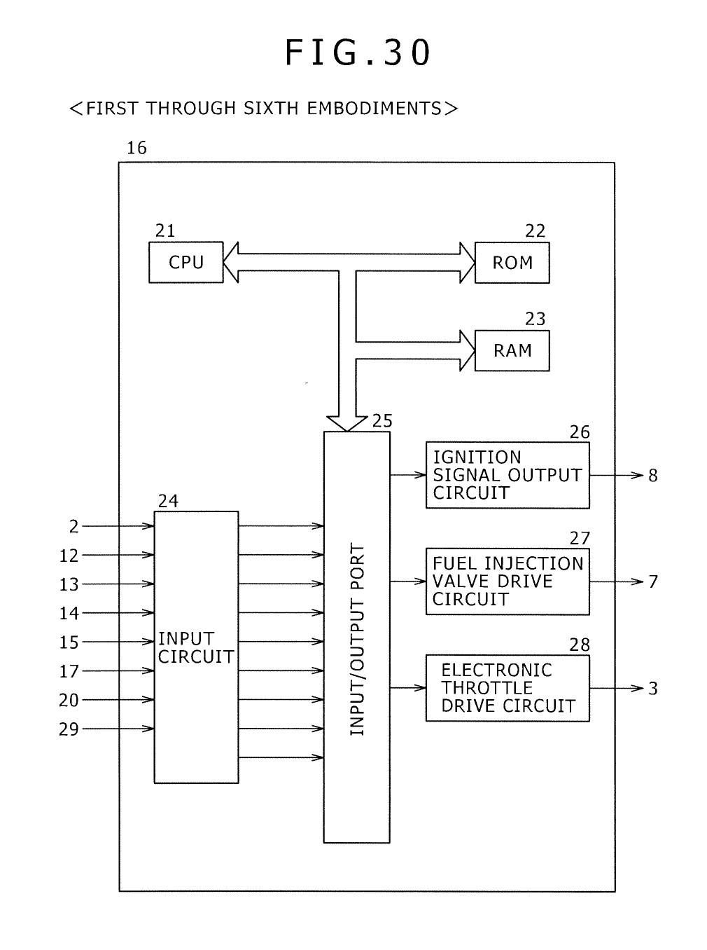

FIG. 30 shows the internal section of the control unit 16. Each of the sensor output values from the air flow sensor 2, the catalyst upstream sensor 12 (in the first embodiment, an air-fuel ratio sensor), the accelerator opening sensor 13, the water temperature sensor 14, the crank angle sensor 15, the throttle angle sensor 17, the catalyst downstream oxygen sensor 20, the intake air temperature sensor 29, and a vehicle speed sensor 30 are input into the ECU16, and after executing signal processing such as noise removal in an input circuit 24, are sent to an input/output port 25. The input port values are stored in a RAM23, and arithmetically processed inside a CPU21. The control program describing the contents of the arithmetical processing is pre-written into the ROM22. After storing the values expressing each of the actuator operating quantities calculated according to the control program into the RAM23, the values are sent to the input/output port 25. The ON/OFF signal sets so that the signal is ON during flow and OFF during non-flow in the primary coil within the ignition output circuit, is set as the spark plug operation signal. The ignition period is the timing from ON to OFF. The signal for the spark plug set in the output port is amplified to the sufficient required energy for combustion in the ignition output circuit 26 and supplied to the spark plug. An ON-OFF signal set so that the fuel injection valve drive signal is ON when the valve is open, and OFF when the valve is closed, is amplified to the sufficient required energy to open the fuel injection valve in the fuel injection valve drive circuit 27 and sent to the fuel injection valve 7. The drive signal to implement the target angle of the electronic throttle 3 is sent to the electronic throttle 3 by way of the electronic throttle drive circuit 28.

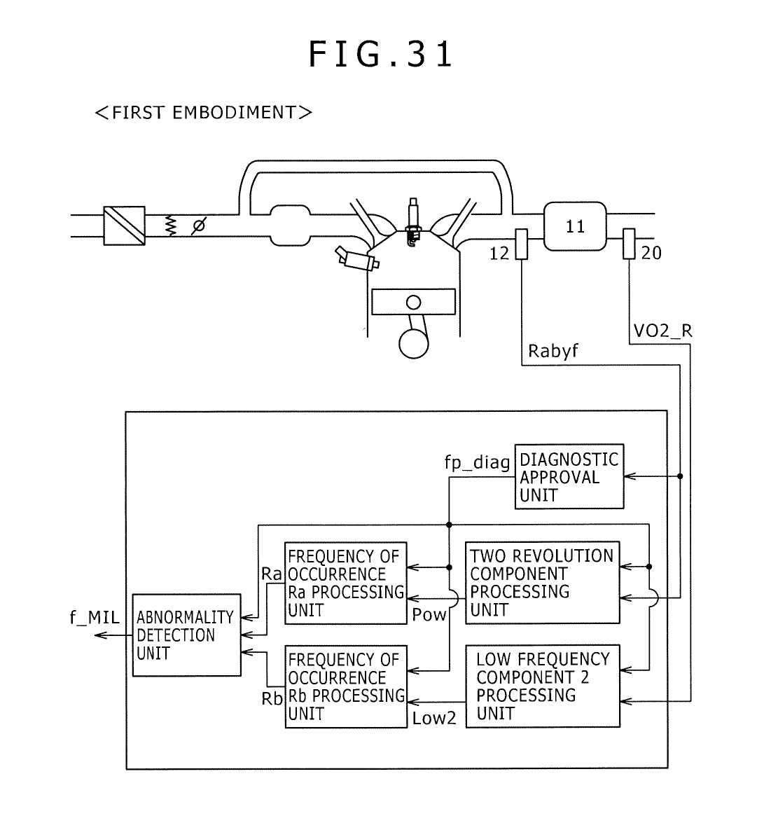

The control programs written into the ROM22 are described below. FIG. 31 is a block diagram showing the overall control. The overall control is configured from the processing units as shown below.

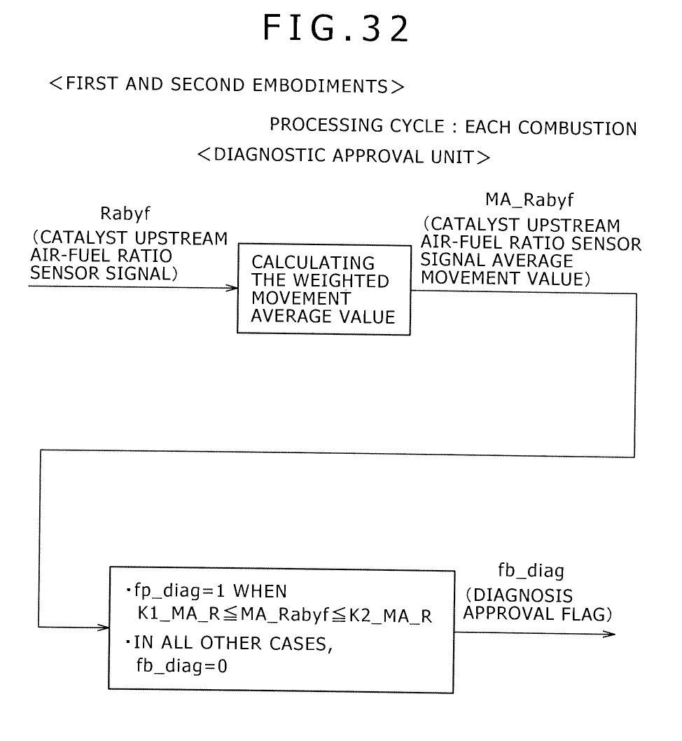

Diagnostic approval unit (FIG. 32)

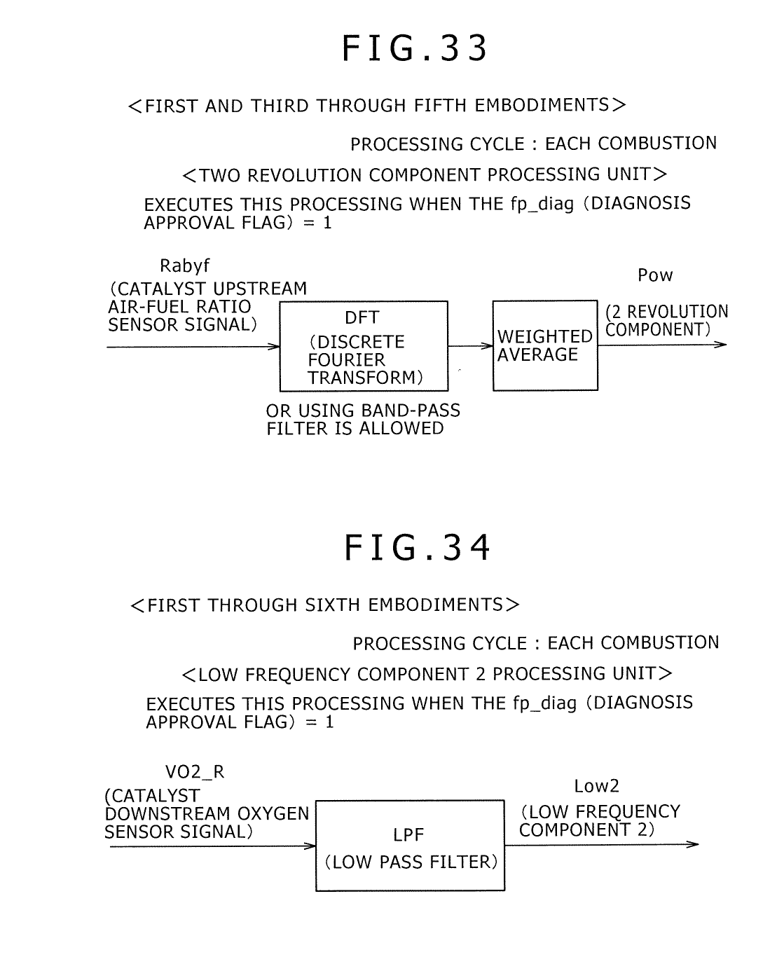

Two revolution component processing unit (FIG. 33)

Low frequency component 2 processing unit (FIG. 34)

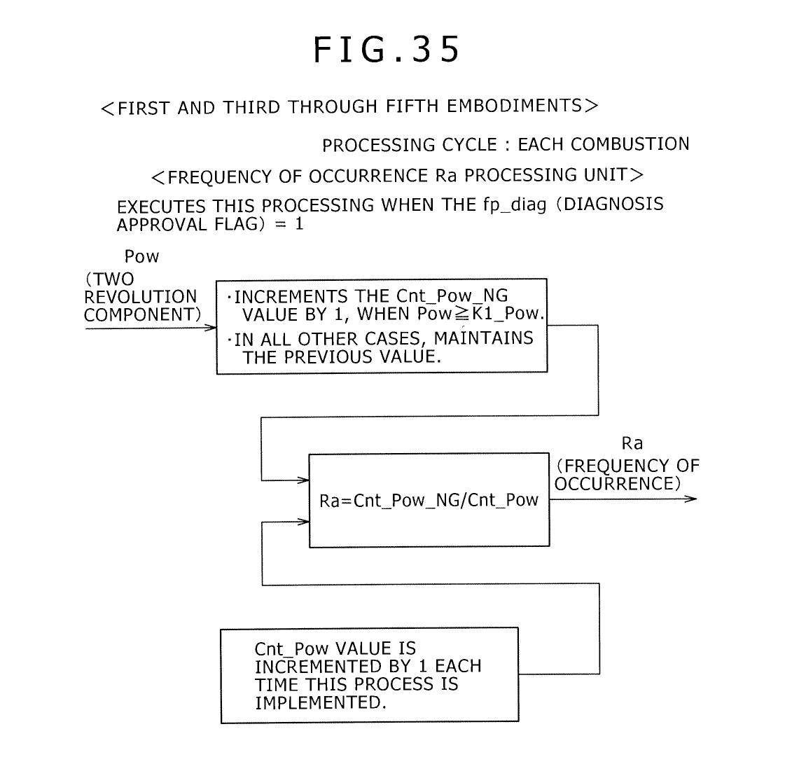

Frequency of occurrence Ra processing unit (FIG. 35)

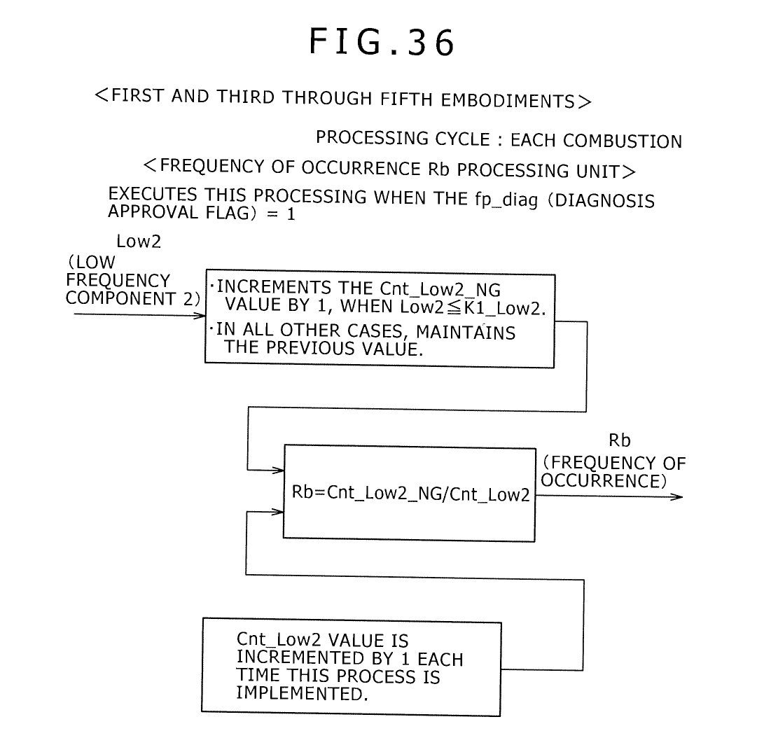

Frequency of occurrence Rb processing unit (FIG. 36)

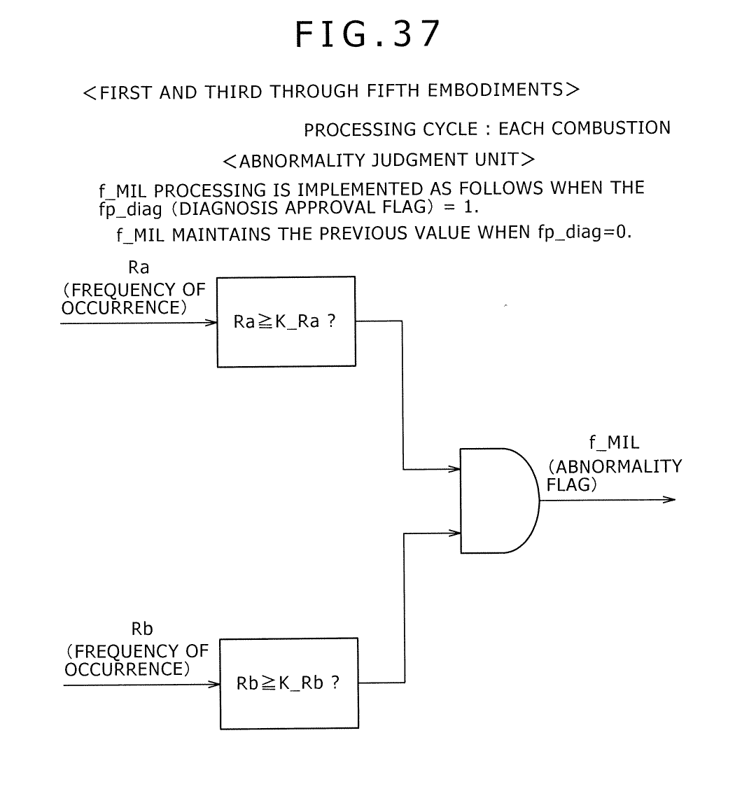

Abnormality judgment unit (FIG. 37)

The “diagnostic approval unit” processes the flag (fp_diag) allowing diagnosis. The “two revolution component processing unit” processes the two revolution component (Pow) of the catalyst upstream air-fuel ratio sensor signal. The “low frequency component 2 processing unit” processes the low frequency component (Low2) of the catalyst downstream oxygen sensor signal. The “frequency of occurrence Ra processing unit” processes the frequency of occurrence (Ra) that the two revolution component (Pow) exceeds a specified value. The “frequency of occurrence Rb processing unit” processes the frequency of occurrence (Rb) that the low frequency component 2 (Low2) deviates from a specified range. The “Abnormality judgment unit” sets the abnormality flag (f_MIL) to 1 when the frequency of occurrence (Ra) exceeded a specified value, and the frequency of occurrence (Rb) exceeded a specified value. Each of the processing units is described in detail next.

### <Diagnostic Approval Unit (FIG. 32)>

This processing unit processes the diagnosis approval flag (fp_diag). The specific processing is shown in FIG. 32. The processing finds the weighted movement average value (MA_Rabyf) of the catalyst upstream air-fuel ratio sensor 12 signal (Rabyf). The processing unit sets fp_diag=1 when K1_MA_R≦MA_Rabyf≦K2_Ma_R. In all other cases, the processing unit sets fp_diag=0. The weighted coefficient for the weighted movement average may be set so that the value (tradeoff value) satisfies both the convergence and tracking according to the driving test results.

### <Two Revolution Component Processing Unit (FIG. 33)>

This processing unit processes the two revolution component (Pow) of the catalyst upstream air-fuel ratio sensor signal. The specific processing is shown in FIG. 33. The processing utilizes the DFT (discrete Fourier transform) to process the two revolution component of the catalyst upstream air-fuel ratio sensor signal (Rabyf). The power spectrum and phase spectrum are found by the Fourier transform but the power spectrum is utilized here. Weighted average processing is performed in order to find the statistical properties and set the two revolution component (Pow). The two revolution component may be found by utilizing a band-pass filter. In this case, weighted average processing is performed after finding the absolute value for the filter output, and the two revolution component (Pow) is set. The weighted coefficient of the weighted average may be set according to the driving test results so that the value (tradeoff value) satisfies both the convergence and the tracking.

### <Low Frequency Component 2 Processing Unit (FIG. 34)>

This processing unit processes the low frequency component (Low2) of the catalyst downstream oxygen sensor signal. The specific processing is shown in FIG. 34. A LPF (low pass filter) is utilized to process the low frequency component (Low2) of the catalyst downstream oxygen sensor signal (V02_R). Essentially, finding the direct current component of the catalyst downstream oxygen sensor signal is preferable but tracking of transient driving requires obtaining a certain margin so that a sufficiently low value is set while taking into account the cut-off frequency of the low pass filter.

### <Frequency of Occurrence Ra Processing Unit (FIG. 35)>

This processing unit processes the frequency of occurrence (Ra) where the two revolution component (Pow) exceeds a specified value. The specific processing is shown in FIG. 35. This processing is implemented when fp_diag=1.

The Cnt_Pow_NG value is incremented by 1 when Pow≧K1_Pow. In all other cases, the previous value is maintained.

The Cnt_Pow value is incremented by 1 each time this processing is implemented.

The processing sets: Ra=Cnt_Pow_NG/Cnt_Pow.

As a general guide, the K1_Pow may be set as the level at steady state performance that the exhaust emissions deteriorate.

### <Frequency of Occurrence Rb Processing Unit (FIG. 36)>

This processing unit processes the frequency of occurrence (Rb) where the low frequency component (Low 2) exceeds a specified value. The specific processing is shown in FIG. 36. This processing is implemented when fp_diag=1.

The Cnt_Low2_NG value is incremented by 1 when Low2≦K1_Low 2. In all other cases, the previous value is maintained.

The Cnt_Low2 value is incremented by 1 each time this processing is implemented.

The processing sets: Rb=Cnt_Low2_NG/Cnt_Low2.

As a general guide, the K1_Low2 may be set as the level at steady state performance that the exhaust emissions deteriorate.

The specifications for the present embodiment detect when the Low2 deviates to the lean side (NOx has worsened), however a threshold value for the rich side may be set in Low2 when concerned that Low2 is deviating to the rich side (CO has worsened).

### <Abnormality Judgment Unit (FIG. 37)>

This processing unit processes the abnormality flag (f_MIL). The specific processing is shown in FIG. 37. The f_MIL in the following processing is implemented when fp_diag=1.

Here, the f_MIL=1 is set when Ra≧k_Ra and Rb≧K_Rb. In all other cases, the f_MIL=0 is set. The f_MIL maintains the previous value when fp_diag=1.

Here, as a general guide, the K_Ra and K_Rb may be set as the level in transient driving operation that the exhaust emissions deteriorate. Assuming for example a realistic driving pattern in an actual environment, the level that exhaust emissions deteriorate at that time may be set as a general guide.

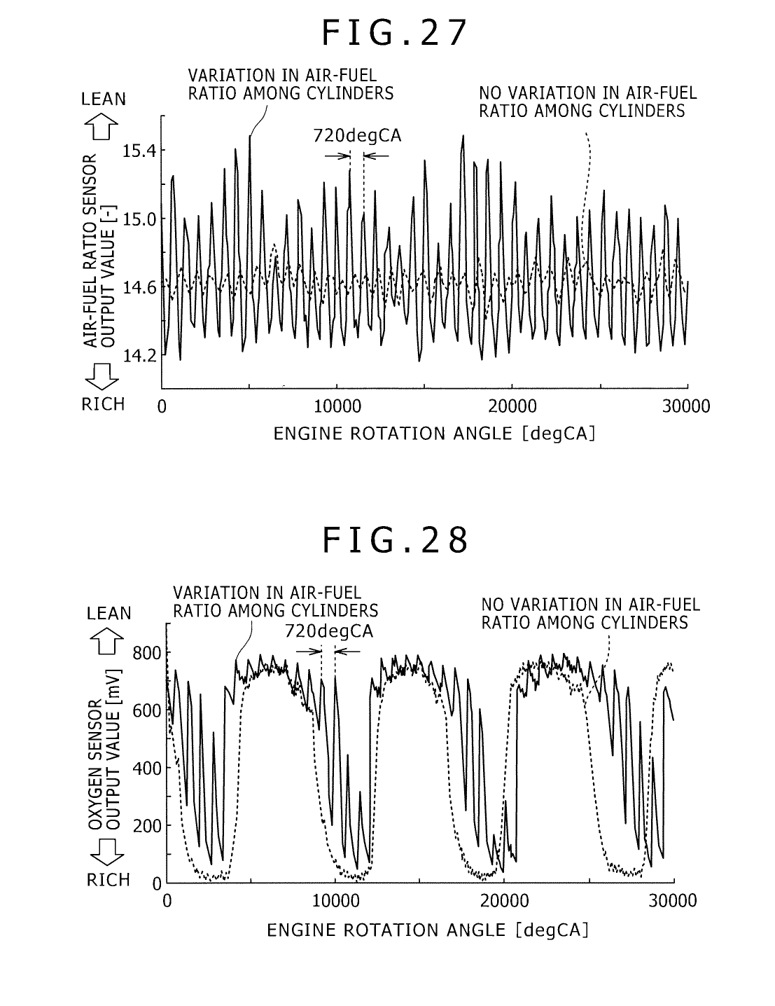

The first embodiment utilized an air-fuel ratio sensor as the catalyst upstream sensor 12 however the same processing can also be implemented when utilizing an oxygen sensor. The reason is that the two revolution component is generated during variations in the air-fuel ratio among cylinders, even cases where using either an air-fuel ratio sensor or oxygen sensor as shown in FIG. 27 and FIG. 28. However each parameter must be reset for utilizing an oxygen sensor.

### Second Embodiment

The first embodiment detected the two revolution component of the catalyst upstream sensor signal. The second embodiment detects the low frequency component of the catalyst upstream sensor signal.

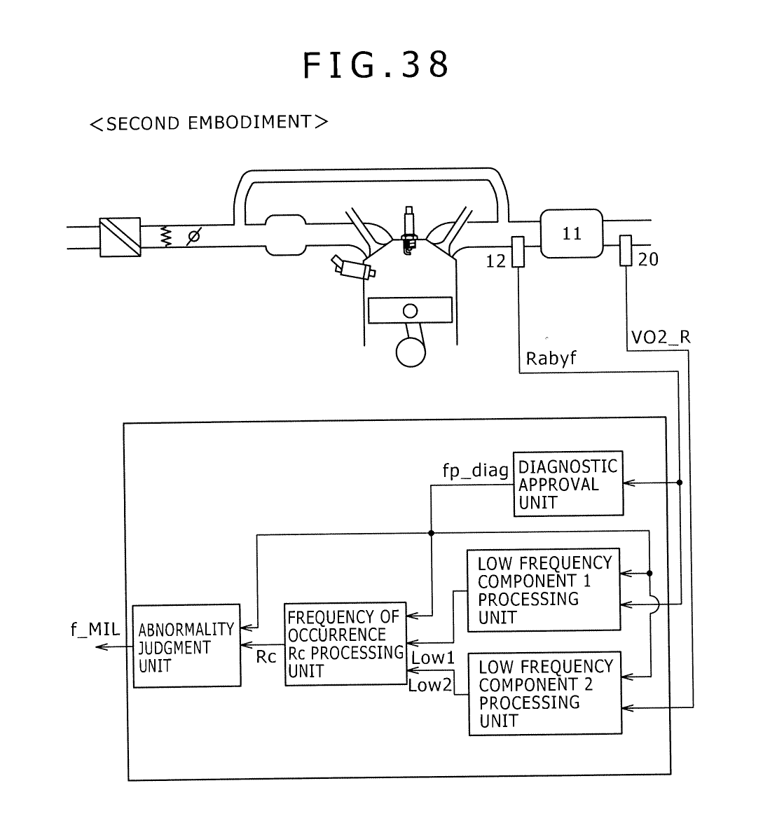

FIG. 29 is a system diagram showing the present embodiment and is the same as the first embodiment so a detailed description is omitted. FIG. 30 is a block diagram showing the internal section of the control unit 16 and is the same as the first embodiment so a detailed description is omitted. The control program written into the ROM22 within FIG. 30 is described next. FIG. 38 is a block diagram showing the overall control and includes the following processing units.

Diagnostic approval unit (FIG. 32)

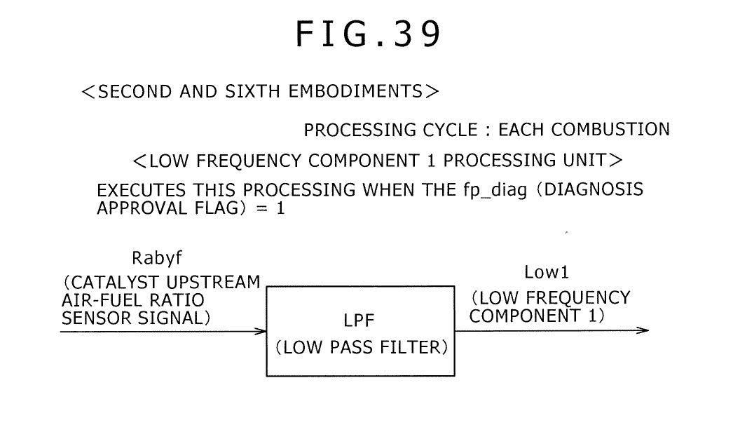

Low frequency component 1 processing unit (FIG. 39)

Low frequency component 2 processing unit (FIG. 34)

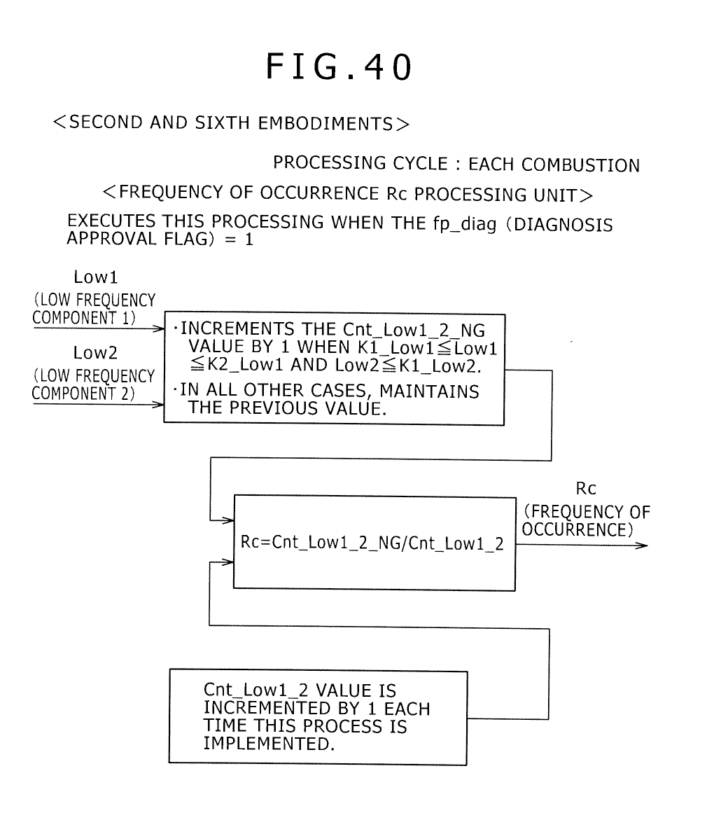

Frequency of occurrence Rc processing unit (FIG. 40)

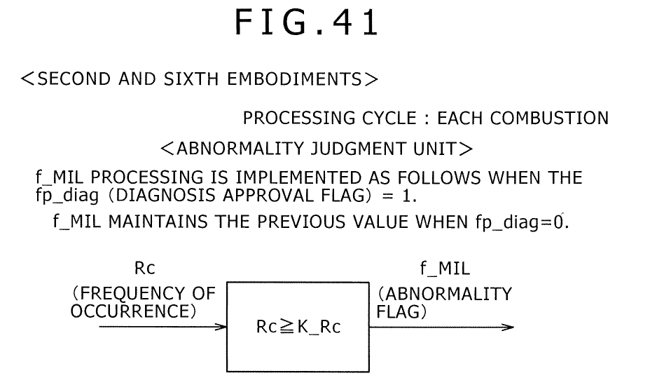

Abnormality judgment unit (FIG. 41)

The “diagnostic approval unit” processes the flag (fp_diag) allowing diagnosis. The “low frequency component 1 processing unit” processes the low frequency component (Low1) of the catalyst upstream air-fuel ratio sensor signal. The “low frequency component 2 processing unit” processes the low frequency component (Low2) of the catalyst downstream oxygen sensor signal. The “frequency of occurrence Rc processing unit” processes the frequency of occurrence (Rc) where the low frequency component 1 (Low1) is within the specified range, and further the low frequency component 2 (Low2) deviates from a specified range. The “abnormality judgment unit” sets the abnormality flag (f_MIL) to 1 when the frequency of occurrence (Rc) exceeded a specified value. Each of the processing units is described in detail next.

### <Diagnostic Approval Unit (FIG. 32)>

This processing unit processes the diagnostic approval flag (fp_diag.). The specific processing is shown in FIG. 32 and is the same as the first embodiment so a detailed description is omitted.

### <Low Frequency Component 1 Processing Unit (FIG. 39)>

This processing unit processes the low frequency component (Low1) of the catalyst upstream air-fuel ratio sensor signal. The specific processing is shown in FIG. 39. A LPF (low pass filter) is utilized to process the low frequency component (Low1) of the catalyst upstream air-fuel ratio sensor signal (Rabyf). Essentially, finding the direct current component of the catalyst upstream air-fuel ratio sensor signal is preferable but tracking of transient driving requires obtaining a certain margin, so that a sufficiently low value is set while taking into account the cut-off frequency of the low pass filter.

### <Low Frequency Component 2 Processing Unit (FIG. 34)>

This processing unit processes the low frequency component (Low2) of the catalyst downstream oxygen sensor signal. The specific processing is shown in FIG. 34 and is the same as the first embodiment so a detailed description is omitted.

### <Frequency of Occurrence Rc Processing Unit (FIG. 40)>

This processing unit processes the frequency of occurrence (Rc) where the low frequency component 1 (Low1) is within the specified range, and also the low frequency component (Low2) is deviating from the specified range. The specific processing is shown in FIG. 40. This processing is implemented when fp_diag=1.

The Cnt_Low1_2_NG value is incremented by 1 when K1_Low1≦Low1≦K2_Low1 and also when Low2≦K1_Low2. In all other cases, the previous value is maintained.

The Cnt_Low1_2 value is incremented by 1 each time this processing is implemented.

The processing sets: Rc=Cnt_Low1_2_NG/Cnt_Low1_2.

The K1_Low1 and K2_Low1 may be set at the high efficiency cleansing range of the catalyst as a general guide. The K2_Low2 may be set at the level of steady state performance that the exhaust emissions deteriorate as a general guide. The specifications for the present embodiment detect when the Low2 deviates to the lean side (NOx has worsened), however a threshold value for the rich side may be set in Low2 when concerned that Low2 is deviating to the rich side (CO has worsened).

### <Abnormality Judgment Unit (FIG. 41)>

This processing unit processes the abnormality flag (f_MIL). The specific processing is shown in FIG. 41. The f_MIL in the following processing is implemented when fp_diag=1

Here, the f_MIL=1 is set when Rc≧k_Rc. In all other cases, the f_MIL=0 is set. The f_MIL maintains the previous value when fp_diag=0.

Here, as a general guide, the K_Rc may be set as the level at transient driving operation that the exhaust emissions deteriorate. Assuming for example a realistic driving pattern in an actual environment, the level that exhaust emissions deteriorate at that time may be set as a general guide.

The second embodiment utilized an air-fuel ratio sensor as the catalyst upstream sensor 12 however the same processing can also be implemented when utilizing an oxygen sensor. However each parameter must be reset for utilizing an oxygen sensor.

### Third Embodiment

The third embodiment corrects the parameters (fuel injection quantity) for catalyst upstream air-fuel ratio feedback control by utilizing the specified frequency component of the catalyst upstream/downstream sensor.

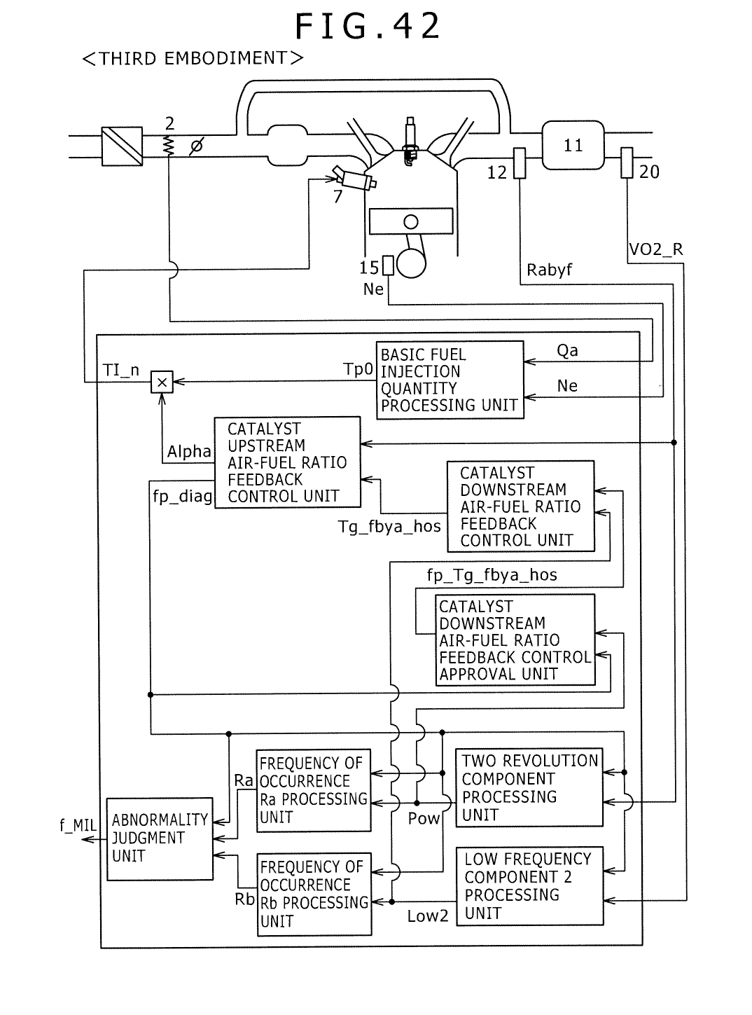

FIG. 29 is a system diagram showing the present embodiment and is the same as the first embodiment so a detailed description is omitted. FIG. 30 is a block diagram showing the internal section of the control unit 16 and is the same as the first embodiment so a detailed description is omitted. The control program written into the ROM22 within FIG. 30 is described next. FIG. 42 is a block diagram showing the overall control and includes the following processing units added from the structure of the first embodiment (FIG. 31).

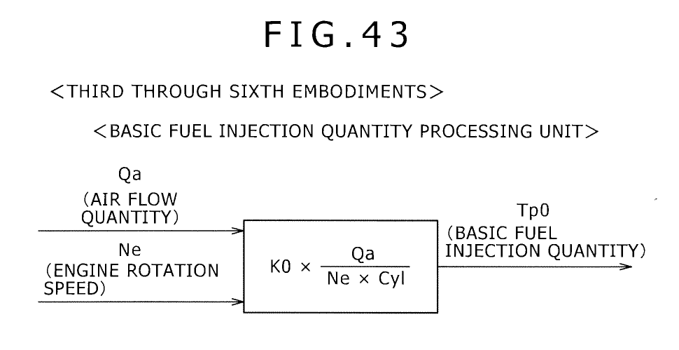

Basic fuel injection quantity processing unit (FIG. 43)

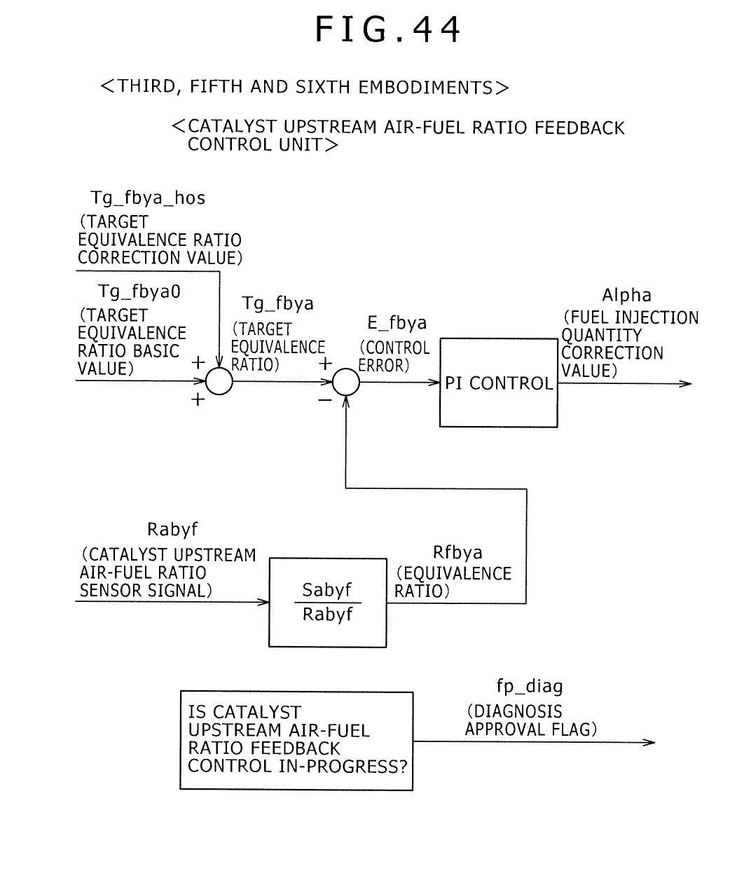

Catalyst upstream air-fuel ratio feedback control unit (FIG. 44)

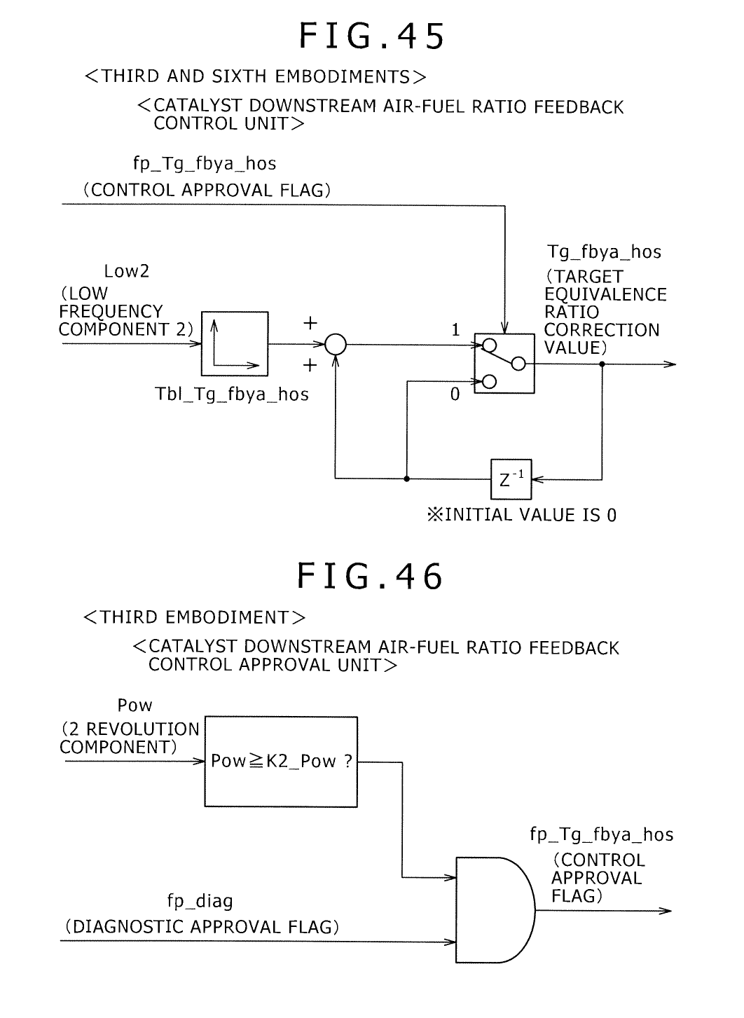

Catalyst downstream air-fuel ratio feedback control unit (FIG. 45)

Catalyst downstream air-fuel ratio feedback control approval unit (FIG. 46)

The “basic fuel injection quantity processing unit” calculates the basic fuel injection quantity (TpO). The “catalyst upstream air-fuel ratio feedback control unit” processes (calculates) the fuel injection quantity correction value (Alpha) for correcting the basic fuel injection quantity (TpO) so that the catalyst upstream air-fuel ratio sensor signal (Rabyf) attains the target value. The “catalyst downstream air-fuel ratio feedback control unit” processes the value (Tg_fbya_hos) for correcting the target value for catalyst upstream air-fuel ratio feedback control, from the low frequency component (Low2) of the catalyst downstream oxygen sensor signal needed to suppress the deterioration in exhaust emission (performance) due to variations in the air-fuel ratio among cylinders. The “catalyst downstream air-fuel ratio feedback control approval unit” processes the flag (fp_Tg_fbya_hos) for approving implementation of catalyst upstream air-fuel ratio feedback control based on the two revolution component (Pow) of the catalyst upstream air-fuel ratio sensor signal.

Each of the processing units is hereafter described in detail. Other than the above, FIG. 42 contains five processing units (approval unit, judgment unit) as below but which are the same as previously described for the first embodiment so a description is omitted.

Two revolution component processing unit (FIG. 33)

Low frequency component 2 processing unit (FIG. 34)

Frequency of occurrence Ra processing unit (FIG. 35)

Frequency of occurrence Rb processing unit (FIG. 36)

Abnormality judgment unit (FIG. 37)

### <Basic Fuel Injection Quantity Processing Unit (FIG. 43)>

This processing unit calculates (or processes) the basic fuel injection quantity (TpO). The specific processing is implemented utilizing the function shown in FIG. 43. Here, Cyl indicates the number of cylinders. The KO is set based on the injector specifications (relation of fuel injection pulse width to fuel injection quantity).

### <Catalyst Upstream Air-Fuel Ratio Feedback Control Unit (FIG. 44)>

This processing unit processes (or calculates) the fuel injection quantity correction value (Alpha). The specific processing is shown in FIG. 44.

Processing unit sets a value which is the target equivalence ratio correction value (Tg_fbya_hos) added to the target equivalence ratio basic value (Tg_fbya0) as the target equivalence ratio (Tg_fbya).

Processing unit sets a value which is the basic air-fuel ratio (Sabyf) divided by the catalyst upstream air-fuel ratio sensor signal (Rabyf) as the equivalence ratio (Rfbya).

Processing unit sets the difference between the target equivalence ratio (Tg_fbya) and the equivalence ratio (Rfbya) as the control error (E_fbya).

Processing unit calculates the fuel injection quantity correction value (Alpha) from the PI control based on the control error (E_fbya).

The basic air-fuel ratio (Sabyf) may be set as the stoichiometric air-fuel ratio equivalent value.

During implementation of this control the diagnosis approval flag (fp_diag) is set to 1.

### <Catalyst Downstream Air-Fuel Ratio Feedback Control Unit (FIG. 45)>

This processing unit calculates (or processes) the target equivalence ratio correction value (Tg_fbya_hos). The specific processing is shown in FIG. 45.

When the control approval flag (fg_Tg_fbya_hos) is 1, the processing unit adds a value from searching the table Tbl_Tg_fbya_hos to the previous value for the target equivalence ratio correction value (Tg_fbya_hos) as the current target equivalence ratio correction value. The table Tbl_Tg_fbya_hos sets the low frequency component (Low2) of the catalyst downstream oxygen sensor signal as the argument.

When the control approval flag (fg_Tg_fbya_hos) is 0, the target equivalence ratio correction value (Tg_fbya_hos) maintains the previous value.

When Low2 is below the specified value, the processing unit applies a positive value (target equivalence ratio to large), and when Low2 is above the specified value, applies 0 or a negative value (target equivalence ratio to small) in the table Tbl_Tg_fbya_hos.

### <Catalyst Downstream Air-Fuel Ratio Feedback Control Approval Unit (FIG. 46)>

This processing unit processes the control approval flag (fg_Tg_fbya_hos). The specific processing is shown in FIG. 46.

Here, fg_Tg_fbya_hos=1 is set when Pow≦K2_Pow and also fp_diag=1.

In all other cases, fg_Tg_fbya_hos=0 is set.

As a general guide, the K2_Pow may be set at the level that the exhaust emissions deteriorate.

### Fourth Embodiment

In the third embodiment, an air-fuel ratio sensor was utilized as the catalyst upstream exhaust sensor 12 but the example in the fourth embodiment shows the case where utilizing an oxygen sensor as the catalyst upstream exhaust sensor 12.

FIG. 29 is system drawing showing the embodiment and is identical to the first embodiment so a detailed description is omitted.

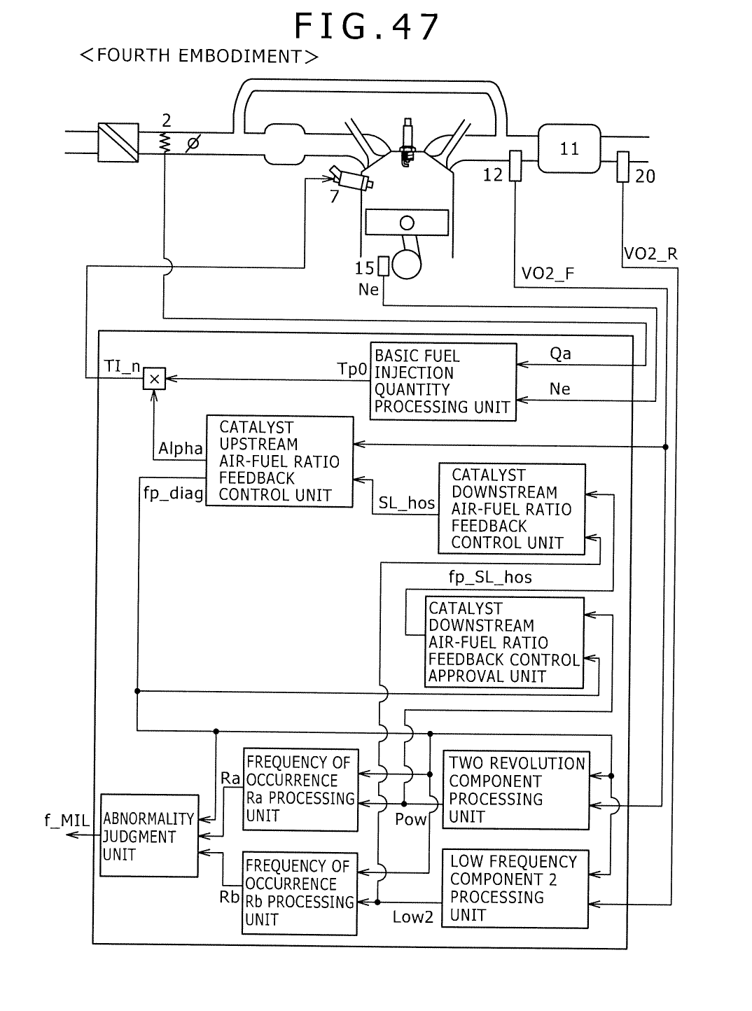

In the present embodiment the catalyst upstream exhaust sensor 12 is an oxygen sensor. FIG. 30 is a block diagram showing the internal section of the control unit 16 and is the same as the first embodiment so a detailed description is omitted. The control program written into the ROM22 within FIG. 30 is described next. FIG. 47 is a block diagram showing the overall control and differs from the third embodiment in including the following processing units.

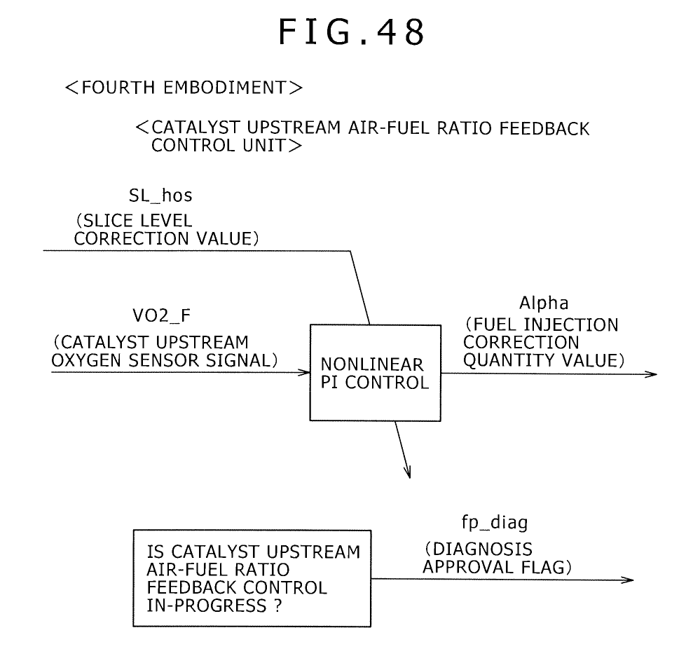

Catalyst upstream air-fuel ratio feedback control unit (FIG. 48)

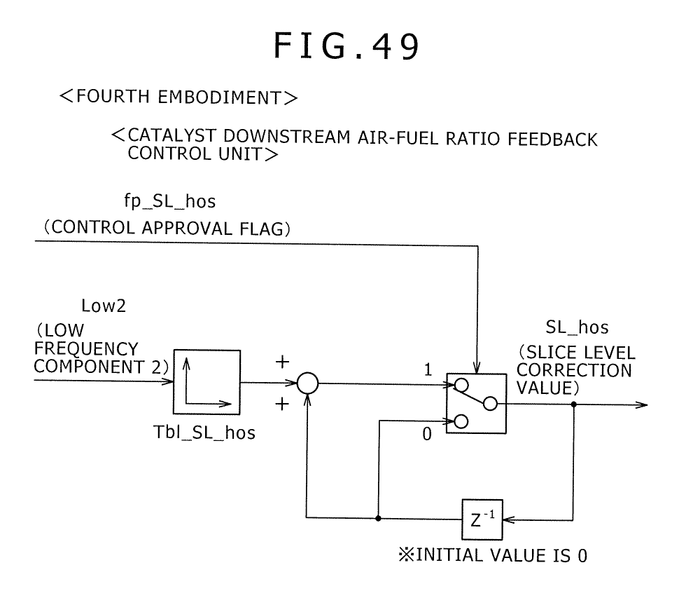

Catalyst downstream air-fuel ratio feedback control unit (FIG. 49)

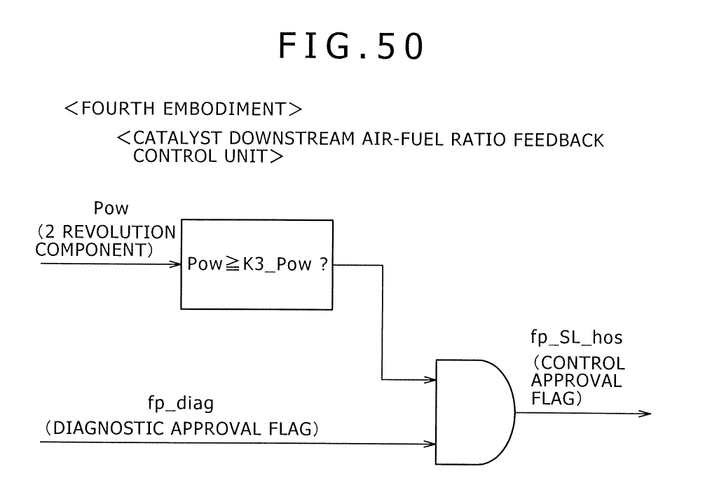

Catalyst downstream air-fuel ratio feedback control approval unit (FIG. 50)

The “catalyst upstream air-fuel ratio feedback control unit” processes the fuel injection quantity correction value (Alpha) to correct the basic fuel injection quantity (TpO) based on the catalyst upstream oxygen sensor signal (V02_F). The “catalyst downstream air-fuel ratio feedback control unit” processes the value (SL_hos) for correcting the slice level of the catalyst upstream air-fuel ratio feedback control from the low frequency component (Low2) of the catalyst downstream oxygen sensor signal for preventing deterioration in exhaust emissions due to variations in the air-fuel ratio among cylinders. The “catalyst downstream air-fuel ratio feedback control approval unit” processes the flag (p_SL_hos) for approving implementation of the previously described catalyst downstream air-fuel ratio feedback control.

Each processing unit is hereafter described in detail. Aside from the above units this embodiment also contains the following A-F processing units (approval unit, judgment unit) but as already described, the A-E units are identical to those in the first embodiment and the F unit is identical to the third embodiment so a description is omitted.

A. Two revolution component processing unit (FIG. 33)
B. Low frequency component 2 processing unit (FIG. 34)
C. Frequency of occurrence Ra processing unit (FIG. 35)
D. Frequency of occurrence Rb processing unit (FIG. 36)
E. Abnormality judgment unit (FIG. 37)
F. Basic fuel injection quantity processing unit (FIG. 43)

### <Catalyst Upstream Air-Fuel Ratio Feedback Control Unit (FIG. 48)>

This processing unit calculates (or processes) the fuel injection quantity correction value (Alpha). The specific processing is shown in FIG. 48.

The processing unit calculates (or processes) the fuel injection quantity correction value (Alpha) from the nonlinear PI control based on the catalyst upstream oxygen sensor signal (V02_F). Nonlinear PI control by utilizing the oxygen sensor signal is known in the related art and so is not described here.

The processing unit corrects the slice level for nonlinear PI control by way of the slice level correction value (SL_hos).

During implementation of this control, the diagnosis approval flag (fp_diag) is set to 1.

### <Catalyst Downstream Air-Fuel Ratio Feedback Control Unit (FIG. 49)>

This processing unit calculates (or processes) the slice level correction value (SL_hos). The specific processing is shown in FIG. 49.

When the control approval flag (fp_SL_hos) is 1, the processing unit adds a value from searching the table Tbl_SL_hos, to the previous slice level correction value (SL_hos) as the current slice level correction value (SL_hos). The table Tbl_SL_hos sets the low frequency component (Low2) of the catalyst downstream oxygen sensor signal as the argument.

When the control approval flag (fp_SL_hos) is 0, the slice level correction value (SL_hos) maintains the previous value.

The table Tbl_SL_hos sets a positive value (slice level to large when the Low2 is less than a specified value, and sets a 0 or a negative value (slice level to small when the Low2 is larger than a specified value.

### <Catalyst Downstream Air-Fuel Ratio Feedback Control Approval Unit (FIG. 50)>

This processing unit processes the control approval flag (fp_SL_hos). The specific processing is shown in FIG. 50.

When Pow≦K3_Pow and also fp_diag=1, then fp_SL_hos=1 is set.

In all other cases, the fp_SL_hos=0 is set.

As a general guide, the K3_Pow may be set as the level that the exhaust emissions deteriorate.

The present embodiment corrected the slice level but may also set the P portion as an inequality by nonlinear PI control.

### Fifth Embodiment

The third embodiment corrected the target equivalence ratio of the catalyst upstream air-fuel ratio feedback control, from the two revolution component of the catalyst upstream air-fuel ratio sensor signal and the low frequency component of the catalyst downstream oxygen sensor signal. The fifth embodiment corrects the target equivalence ratio of the catalyst upstream air-fuel ratio feedback control, from the frequency of occurrence Ra that the two revolution component of the catalyst upstream air-fuel ratio sensor signal exceeds a specified value and the frequency of occurrence Rb that the low frequency component of the catalyst downstream oxygen sensor signal deviated from the specified range.

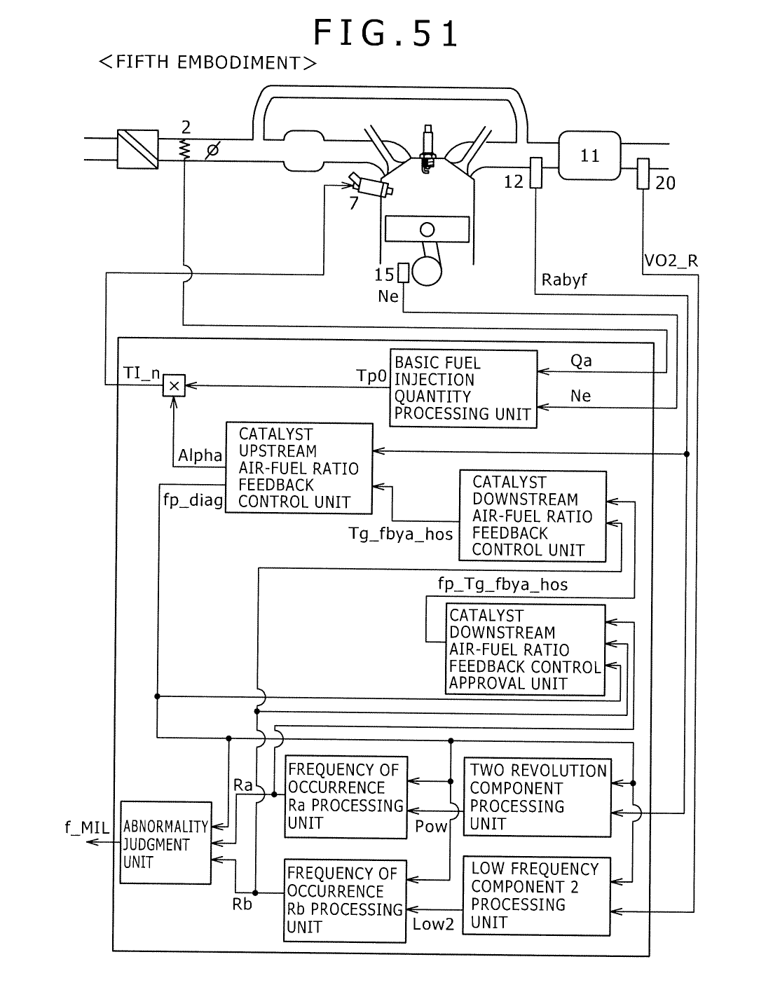

FIG. 29 is a system diagram showing the present embodiment and is the same as the first embodiment so a detailed description is omitted. The catalyst upstream exhaust sensor 12 is an oxygen sensor in this embodiment. FIG. 30 is a block diagram showing the internal section of the control unit 16 and is the same as the first embodiment so a detailed description is omitted. The control program written into the ROM22 within FIG. 30 is described next. FIG. 51 is a block diagram showing the overall control and differs from the third embodiment in including the following two processing units.

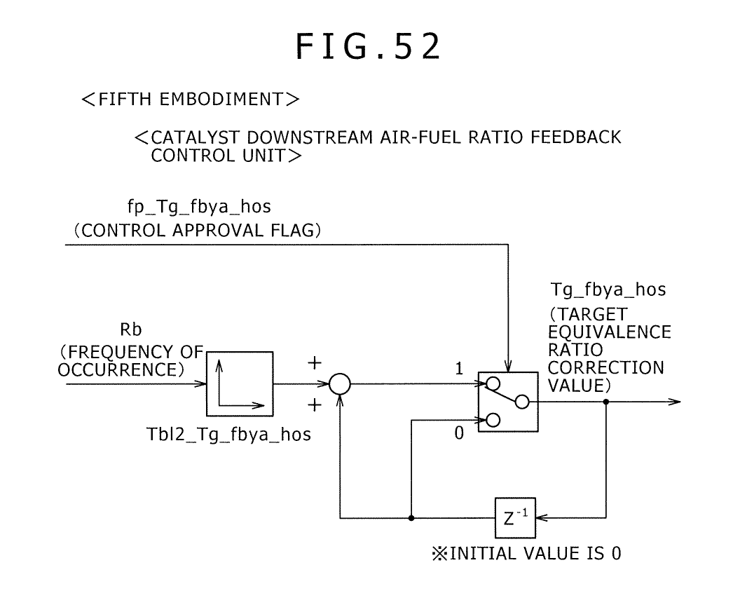

Catalyst downstream air-fuel ratio feedback control unit (FIG. 52)

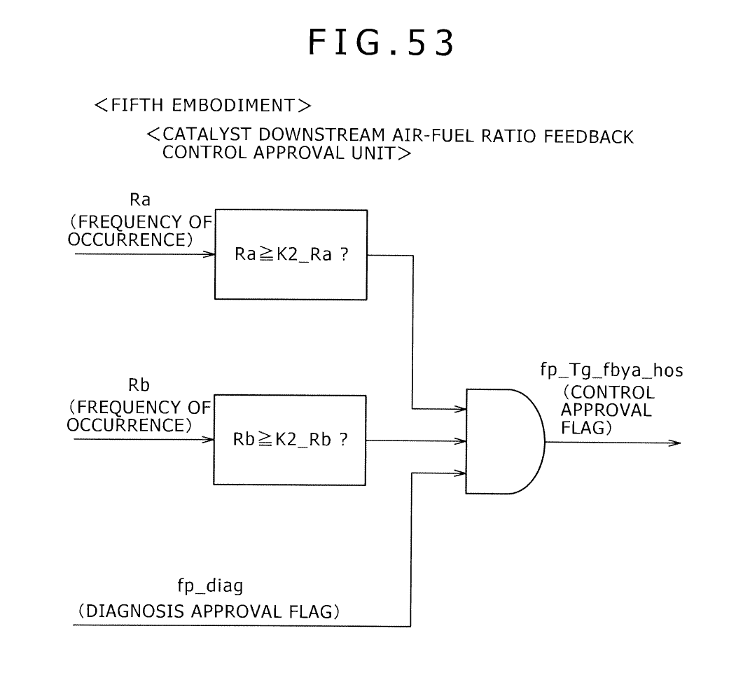

Catalyst downstream air-fuel ratio feedback control approval unit (FIG. 53)

The “basic fuel injection quantity processing unit” calculates the basic fuel injection quantity (TpO). The “catalyst upstream air-fuel ratio feedback control unit” processes (or calculates) the fuel injection quantity correction value (Alpha) for correcting the basic fuel injection quantity (TpO) so that the catalyst upstream air-fuel ratio sensor signal (Rabyf) attains the target value. The “catalyst downstream air-fuel ratio feedback control unit” processes the value (Tg_fbya_hos) for correcting the target value for catalyst upstream air-fuel ratio feedback control, from the frequency of occurrence (Rb) that the low frequency component of the catalyst downstream oxygen sensor signal deviated from the specified range. The “catalyst downstream air-fuel ratio feedback control approval unit” processes the flag (fp_Tg_fbya_hos) for approving implementation of the previously described catalyst downstream air-fuel ratio feedback control based on the frequency of occurrence (Ra) that the two revolution component of the catalyst upstream air-fuel ratio sensor signal exceeded a specified value. Each processing unit is hereafter described in detail. Aside from the above units, this embodiment also contains the following A-G processing units (approval unit, judgment unit) in FIG. 51, but as already described, the A-E units are identical to those in the first embodiment, and the F and G units are identical to the third embodiment so a description is omitted.

A. Two revolution component processing unit (FIG. 33)
B. Low frequency component 2 processing unit (FIG. 34)
C. Frequency of occurrence Ra processing unit (FIG. 35)
D. Frequency of occurrence Rb processing unit (FIG. 36)
E. Abnormality judgment unit (FIG. 37)
F. Basic fuel injection quantity processing unit (FIG. 43)
G. Catalyst upstream air-fuel ratio feedback control unit (FIG. 44)

### <Catalyst Downstream Air-Fuel Ratio Feedback Control Unit (FIG. 52)>

This processing unit calculates (or processes) the target equivalence ratio correction value (Tg_fbya_hos). The specific processing is shown in FIG. 52.

When the control approval flag (fp_Tg_fbya_hos) is 1, the processing unit adds a value from searching the table Tbl2_Tg_fbya_hos, to the previous value for the target equivalence ratio correction value (Tg_fbya_hos) as the current target equivalence ratio correction value (Tg_fbya_hos). The table Tbl2_Tg_fbya_hos sets the frequency of occurrence (Rb) that the low frequency component of the catalyst downstream oxygen sensor signal deviated from the specified range as the argument.

When the control approval flag (fp_Tg_fbya_hos) is 0, the target equivalence ratio correction value (Tg_fbya_hos) maintains the previous value.

When Rb is above the specified value, then the table Tbl2_Tg_fbya_hos applies a positive value (target equivalence ratio to LARGE (large)), and when Rb is below the specified value, applies a 0 or a negative value (target equivalence ratio small.

### <Catalyst Downstream Air-Fuel Ratio Feedback Control Approval Unit (FIG. 53)>

This processing unit calculates (or processes) the control approval flag (fp_Tg_fbya_hos). The specific processing is shown in FIG. 53.

When Ra≧K2_Ra and also Rb≧K2_Rb, and also fp_diag=1, then fg_Tg_fbya_hos=1 is set.

In all other cases, the fg_Tg_fbya_hos=0 is set.

As a general guide, the K2_Ra and K2_Rb may be set as the level that the exhaust emissions deteriorate.

In the fifth embodiment the catalyst upstream sensor 12 was an air-fuel ratio sensor however the same processing can be implemented for the case where utilizing an oxygen sensor. However, each parameter must be reset for utilizing an oxygen sensor. Also the correction parameter may be set to the slice level as shown in the fourth embodiment, or may set the P portion as an inequality by nonlinear PI control.

### Sixth Embodiment

The third embodiment corrected the target equivalence ratio of the catalyst upstream air-fuel ratio feedback control, from the two revolution component of the catalyst upstream air-fuel ratio sensor signal and the low frequency component of the catalyst downstream oxygen sensor signal. The sixth embodiment corrects the target equivalence ratio of the catalyst upstream air-fuel ratio feedback control, from the low frequency component of the catalyst upstream air-fuel ratio sensor signal and the low frequency component of the catalyst downstream oxygen sensor signal.

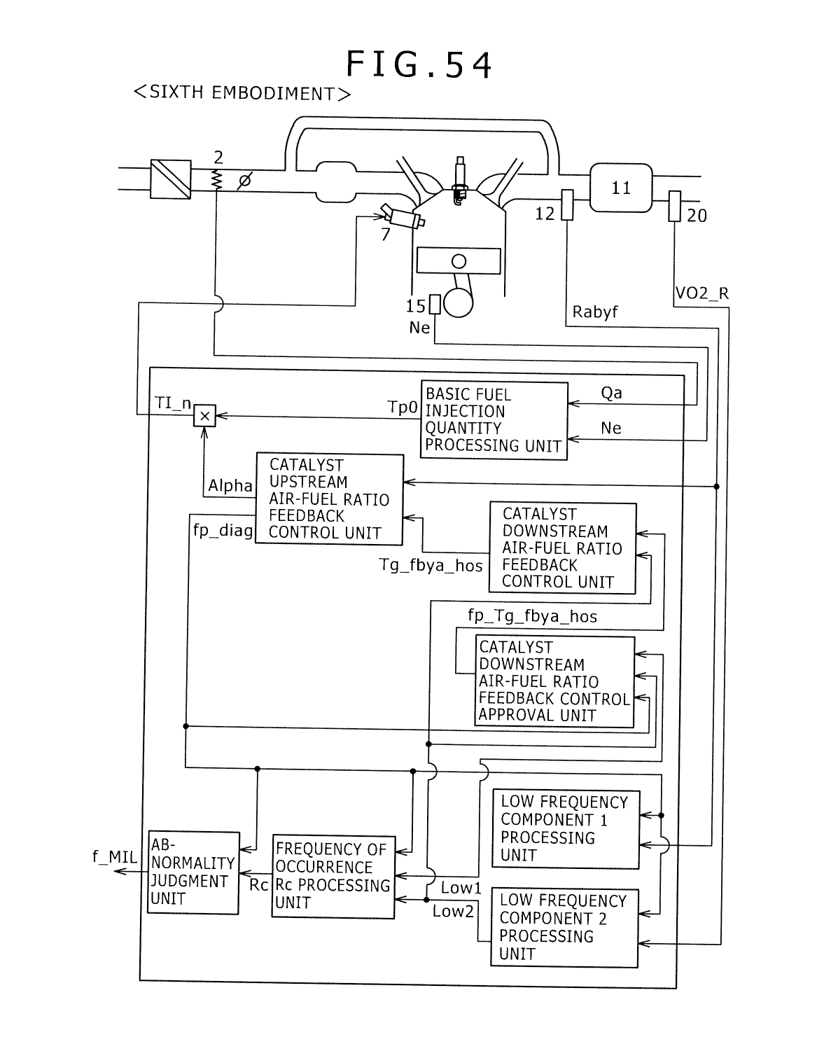

FIG. 29 is a system diagram showing the present embodiment and is the same as the first embodiment so a detailed description is omitted. FIG. 30 is a block diagram showing the internal section of the control unit 16 and is the same as the first embodiment so a detailed description is omitted. The control program written into the ROM22 within FIG. 30 is described next. FIG. 54 is a block diagram showing the overall control and differs from the structure of the second embodiment (FIG. 38) in including the following processing units.

Basic fuel injection quantity processing unit (FIG. 43)

Catalyst upstream air-fuel ratio feedback control unit (FIG. 44)

Catalyst downstream air-fuel ratio feedback control unit (FIG. 45)

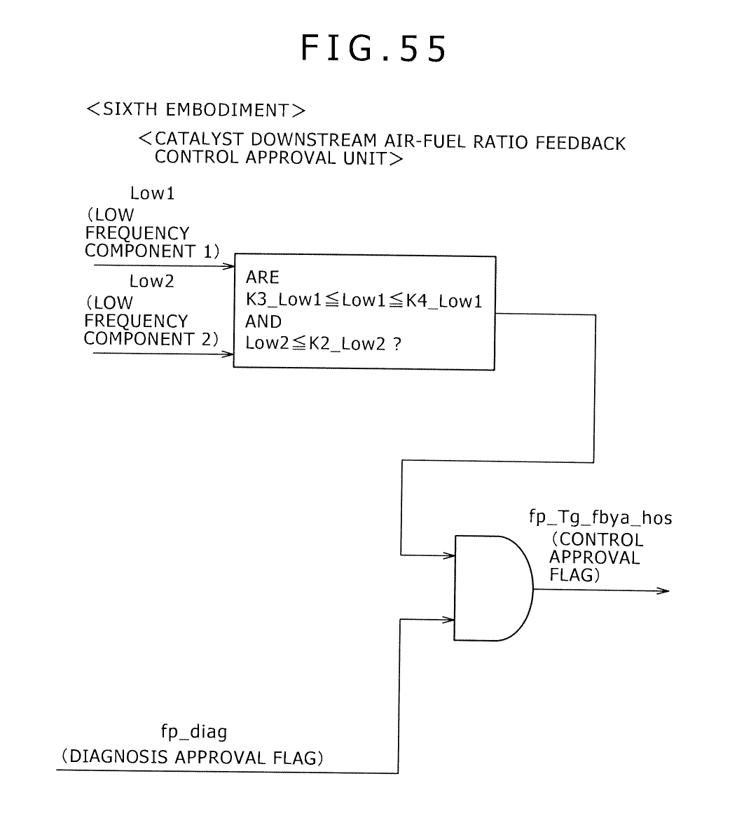

Catalyst downstream air-fuel ratio feedback control approval unit (FIG. 55)

The “basic fuel injection quantity processing unit” calculates the basic fuel injection quantity (TpO). The “catalyst upstream air-fuel ratio feedback control unit” processes (or calculates) the fuel injection quantity correction value (Alpha) for correcting the basic fuel injection quantity (TpO) so that the catalyst upstream air-fuel ratio sensor signal (Rabyf) attains the target value. The “catalyst downstream air-fuel ratio feedback control unit” processes the value (Tg_fbya_hos) for correcting the target value for the catalyst upstream air-fuel ratio feedback control, from the low frequency component (Low2) of the catalyst downstream oxygen sensor signal needed to suppress the deterioration in exhaust emission (performance) due to variations in the air-fuel ratio among cylinders. The “catalyst downstream air-fuel ratio feedback control approval unit” processes the flag (fp_Tg_fbya_hos) for approving implementation of the catalyst downstream air-fuel ratio feedback control based on the low frequency component (Low 1) component of the catalyst upstream air-fuel ratio sensor signal, and the low frequency component (Low2) of the catalyst downstream oxygen sensor signal. Each processing unit is hereafter described in detail. Aside from the above units, this embodiment also contains the following A-G processing units (approval unit, judgment unit) in FIG. 54, but as already described, the A-D units are identical to those in the second embodiment, and the E and G units are identical to the third embodiment so a description is omitted.

A. Low frequency component 1 processing unit (FIG. 39)
B. Low frequency component 2 processing unit (FIG. 34)
C. Frequency of occurrence Rc processing unit (FIG. 40)
D. Abnormality judgment unit (FIG. 41)
E. Basic fuel injection quantity processing unit (FIG. 43)
F. Catalyst upstream air-fuel ratio feedback control unit (FIG. 44)
G. Catalyst downstream air-fuel ratio feedback control unit (FIG. 45)

### <Catalyst Downstream Air-Fuel Ratio Feedback Control Approval Unit (FIG. 55)>

This processing unit processes the control approval flag (fp_Tg_fbya_hos). The specific processing is shown in FIG. 55.

Here, when K3_Low1≦Low1≦K4_Low1 and also Low2≦K2_Low2 then fp_Tg_fbya_hos=1 is set.

In all other cases, the fg_Tg_fbya_hos=0 is set.

As a general guide, the K3_Low1 and K4_Low1 may be set as the high efficiency cleansing range of the catalyst. The K2_Low2 may be set as the level that the exhaust emissions deteriorate as a general guide.

In the sixth embodiment the catalyst upstream sensor 12 was an air-fuel ratio sensor however the same processing can be implemented for the case where utilizing an oxygen sensor. However, each parameter must be reset for utilizing an oxygen sensor. Also the correction parameter may be set to the slice level as shown in the fourth embodiment, or may set the P portion as an inequality by nonlinear PI control.

The feedback control parameter may be corrected based on the “low frequency component 1 (Low1) of the catalyst upstream air-fuel ratio sensor (oxygen sensor) signal that is within the specified range; and also the frequency of occurrence (Rc) in which the low frequency component 2 (Low2) of the catalyst downstream oxygen sensor signal deviates from the specified range.”

### LIST OF REFERENCE SIGNS

1 Air cleaner
2 Air flow sensor
3 Electronic throttle
4 Intake pipe
5 Collector
6 Accelerator
7 Fuel injection valve
8 Spark plug
9 Engine
10 Exhaust pipe
11 Three way catalyst
12 Air-fuel ratio sensor (catalyst upstream sensor)
13 Accelerator opening sensor
14 Water temperature sensor
15 Crank angle sensor
16 Control unit
17 Throttle angle sensor
18 Exhaust return pipe
19 Exhaust return quantity adjuster valve
20 Catalyst downstream oxygen sensor
21 CPU mounted within control unit
22 ROM mounted within control unit
23 RAM mounted within control unit
24 Input circuit for each sensor mounted within the control unit
25 Port for inputting each type of sensor signal and outputting an actuator operating signal
26 Ignition output circuit for outputting drive signals to the spark plug at the correct timing
27 Fuel injection valve drive circuit for outputting the correct pulse to the fuel injection valve
28 Electronic throttle drive circuit
29 Intake air temperature sensor

1.-38. (canceled)

39. An engine control device, characterized by comprising:
a means to calculate a specified frequency component A in a signal of a catalyst upstream sensor;
a means to calculate a specified frequency component B in a signal of a catalyst downstream sensor; and
an exhaust emission deterioration detection means to detect deterioration in exhaust emissions due to a variation in air-fuel ratio among engine cylinders based on the specified frequency component A and the specified frequency component B,
wherein
the catalyst upstream sensor is an air-fuel ratio sensor or an O2 sensor,
the catalyst downstream sensor is an air-fuel ratio sensor or an O2 sensor,
the means to calculate the specified frequency component A is a means to calculate a frequency component A equivalent to a period that the engine makes two revolutions (hereafter, two revolution component),
the means to calculate the specified frequency component B is at least a means to calculate a frequency component B lower than a frequency equivalent to the period that the engine makes two revolutions, and
processing of the exhaust emission deterioration detection means is implemented so that an output of the catalyst upstream sensor is within a specified range when implementing feedback control to control an operating state of the engine.

40. The engine control device according to claim 39, wherein
the means to calculate the two revolution component A is a band-pass filter or a Fourier transform.

41. The engine control device according to claim 39, wherein
the means to calculate the specified frequency component B is a low pass filter.

42. The engine control device according to claim 39, further comprising:
a means to judge that a variation in the air-fuel ratio among cylinders has occurred when the two revolution component A exceeds a specified value.

43. The engine control device according to claim 39, further comprising:
a means to calculate a frequency of occurrence Ra where the two revolution component A exceeds a specified value.

44. The engine control device according to claim 39, further comprising:
a means to calculate a frequency of occurrence Rb where the low frequency component B deviates from a specified range.

45. The engine control device according to claim 39, wherein
the means to calculate the specified frequency component A is at least a means to calculate a frequency component A lower than a frequency equivalent to the period that the engine makes two revolutions.

46. The engine control device according to claim 45, wherein
the means to calculate the specified frequency component A is a low pass filter.

47. The engine control device according to claim 46, further comprising:
a means to judge that the exhaust emissions downstream of the catalyst have deteriorated due to variations in the air-fuel ratio among cylinders, when a frequency of occurrence Rc exceeded a specified value.

48. The engine control device according to claim 38, wherein the engine control device implements at least:
the means to calculate the specified frequency component A, the means to calculate the specified frequency component B, and the exhaust emission deterioration detection means to detect deterioration in exhaust emission, when the output of the catalyst upstream sensor or an average value within a specified period of the catalyst upstream exhaust sensor output is in a specified range.

49. The engine control device according to claim 39, further comprising:
a means to correct a fuel injection quantity or an intake air quantity based on a size of the two revolution component A.

50. The engine control device according to claim 39, further comprising:
means to correct a correction value for feedback control based on the signal of the catalyst upstream sensor and/or a feedback correction value based on the signal of the catalyst downstream sensor, based on a size of the two revolution component A.

51. The engine control device according to claim 43, further comprising:
a means to correct a fuel injection quantity or an intake air quantity based on the frequency of occurrence Ra.

52. The engine control device according to claim 43, further comprising:
a means to correct a correction value for feedback control based on the signal of the catalyst upstream sensor and/or a feedback correction value based on the signal of the catalyst downstream sensor, based on the frequency of occurrence Ra.

53. The engine control device according to claim 39, further comprising:
a means to correct a fuel injection quantity or an intake air quantity so that the low frequency component B is within a specified range when the two revolution component A exceeds a specified value.
